(19) United States
(12) Patent Application Publication
(10) Pub. No.: US 2023/0219484 A1
(43) Pub. Date: Jul. 13, 2023

(54) Systems and Methods for Various Systems of a Vehicle

(71) Applicant: Atlis Motor Vehicles, Inc., Mesa, AZ (US)

(72) Inventors: Mark Hanchett, Mesa, AZ (US); Benoit le Bourgeois, Mesa, AZ (US)

(73) Assignee: Atlis Motor Vehicles, Inc., Mesa, AZ (US)

(21) Appl. No.: 18/114,301

(22) Filed: Feb. 27, 2023

Related U.S. Application Data
(60) Provisional application No. 63/314,796, filed on Feb. 28, 2022.

(51) Int. Cl. B60Q 1/00; B60Q 1/34; B60Q 1/44; B60Q 1/04; B60Q 5/00; B60Q 9/00

(52) U.S. Cl. CPC B60Q 1/0023; B60Q 1/346; B60Q 1/44; B60Q 1/04; B60Q 5/00; B60Q 9/008; B60Q 2400/00

(57) ABSTRACT

Systems for a vehicle include a sound system that detects and compensate for objects that block or muffle sound in the interior of the vehicle; light bars positioned under the headliner of the vehicle or on the front or back of the vehicle that can emulate headlights, taillights, brake lights and turn lights; external light fixtures that are symmetrical around a centerline and can be placed at any position on the front or back of the vehicle without structural change and a collision detection system.

### BACKGROUND

Embodiments of the present invention relate to systems that are part of a vehicle and in particular to a sound system, light bars, headlights/taillights and a collision detection system of a vehicle.

Vehicles include various systems that perform functions. The systems enable the vehicle to operate. Vehicle users may benefit from improvements in the sound system, light bars, the headlights/taillights and the collision detection systems of the vehicle.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1A is a top view of an interior of a vehicle.

FIG. 1B is a top view of the interior of the vehicle overlaid with a sound map.

FIG. 2A is a top view of the interior of the vehicle.

FIG. 2B is a top view of the interior of the vehicle overlaid with a sound map.

FIG. 3 is a right-side view of the interior of the vehicle.

FIG. 4 is a right-side view of the interior of the vehicle.

FIG. 5 is a top view of the interior of the vehicle.

FIG. 6 is a right-side view of the interior of the vehicle.

FIG. 7 is a block diagram of an example embodiment of a sound system according to various aspects of the present disclosure.

FIG. 8 is a front view of a vehicle with light bars according to various aspects of the present disclosure.

FIG. 9 is a cross-section view of the interior of a cabin portion of the vehicle showing a first light bar and a second light bar along the line 9-9.

FIG. 10 is example embodiment of illuminated light bars.

FIG. 11A is another example embodiment of illuminated light bars.

FIG. 11B is a top view of the vehicle with exterior light bars according to various aspects of the present disclosure.

FIG. 11C is a block diagram of an example embodiment of a light bar system according to various aspects of the present disclosure.

FIG. 12A is a diagram of an example embodiment of a light fixture according to various aspects of the present disclosure.

FIG. 12B is a top view diagram of the light fixture of FIG. 12A showing the horizontal field-of-view of the cameras.

FIG. 12C is a top view diagram of the light fixture of FIG. 12A showing the horizontal field-of-capture of the microphones.

FIG. 12D is a top view diagram of the light fixture of FIG. 12A showing the horizontal field-of-illumination and beam arc of the projector light.

FIG. 12E is a top view of the vehicle with an enlarged view of four light fixtures indicating their relative positions on the vehicle.

FIG. 12F is a front view of the vehicle showing the positions of the front light fixtures.

FIG. 12G is a rear view of the vehicle showing the positions of the rear light fixtures.

FIG. 12H is a top view of the vehicle with an enlarged view of another embodiment of light fixtures indicating their relative positions on the vehicle.

FIG. 12I is a front view of the other embodiment of the light fixtures.

FIG. 12J of a system for controlling the light fixtures in cooperation with various vehicle systems.

FIG. 13 is a diagram of the vehicle with an embodiment of a collision detection system in accordance with various aspects of the present disclosure.

FIG. 14 is a diagram of an example situation of a potential collision.

FIG. 15 is a diagram of another example situation of a potential collision.

FIG. 16 is a diagram of another example situation of a potential collision.

FIG. 17 is a diagram of another example situation of a potential collision.

FIG. 18 is a diagram of another example situation of a potential collision.

FIG. 19 is a diagram of another example situation of a potential collision.

FIG. 20 is an example embodiment of a collision detection system.

### DETAILED DESCRIPTION

### Overview

### Sound System

The speakers of a sound system in the vehicle provide sound (e.g., music, news, phone conversation) to the occupants of the vehicle. The content (e.g., items being transported, objects, people) inside the vehicle may change from time to time. Some items may interfere with delivery of sound to one or more occupants of the vehicle.

In an example embodiment, the sound system includes a plurality of sensors (e.g., microphones) positioned around an interior of the vehicle. The microphones detect the volume of the sound delivered to the various positions inside the vehicle. The information from the microphones is analyzed to determine whether an object in the vehicle is blocking transmission of sound to one or more occupants of the vehicle. In the event that the sound from one or more speakers is blocked and cannot travel in whole or part to a portion of the vehicle, the volume of the sound provided by the speakers being blocked or other speakers may be adjusted in an attempt to provide a desired level of sound to each occupant.

### Light Bars

A vehicle may include one or more light bars. A light bar may be positioned inside the vehicle and oriented to provide light to the exterior of the vehicle. A light bar may be positioned outside of the vehicle and oriented to provide light forward or behind the vehicle. A light bar may be oriented forward in (e.g., toward the front of) the vehicle or rearward in (e.g., toward the back of) the vehicle. The light bar may provide additional light on the outside of the vehicle for operation in darkness. A portion of a light bar may emulate headlights, taillights and/or daytime running lights of the vehicle. The light bar may provide lights and signaling to conform to vehicle regulations, such as emulating the light provided by and the operation of headlights, taillights, brake lights, turn lights and/or daytime running lights of the vehicle. A light bar may provide lights that indicate an emergency condition.

In an example embodiment, a forward-facing light bar is positioned in the interior of the vehicle. The forward-facing light bar is positioned behind the windshield and is covered by the headliner of the vehicle. The light provided by the forward-facing light bar shines through the windshield to illuminate an area in front of the vehicle. The headliner blocks light from the light bar from entering the interior of the vehicle. In another example embodiment, a forward-facing light bar is positioned on an exterior of the vehicle toward a front of the vehicle. The light bar emulates the operation of the headlights. In another example embodiment, a rearward-facing light bar is positioned in the interior the vehicle. The rearward-facing light bar is positioned behind the rear window and is covered by the headliner of the vehicle. Again, the headliner blocks light from the light bar from entering the interior of the vehicle. The light provided by the rearward-facing light bar shines through the rear window to illuminate an area behind the vehicle. In another example embodiment, a rearward-facing light bar is positioned on an exterior the vehicle toward a rear of the vehicle. The light bar emulates the operation of the taillights.

### External Light Fixture

in an example embodiment, a light fixture is configured to be positioned at any location on a vehicle to perform, at least in part, the functions of a headlight, a taillight, a brake light, turn lights, and/or daytime running lights. The light fixture includes two or more cameras (e.g., video), two or more microphones, at least one speaker, at least one projector light and a light panel. The light sources of the light panel can display a plurality of colors at a plurality of intensities (e.g., brightness) two emulate lights (e.g., headlights, taillights, turn signals, brake lights) that are generally required on a vehicle.

The cameras, microphones, speaker and projector light cooperate with other systems of the vehicle to provide different methods for operating the systems of the vehicle. For example, the speakers may capture the voice of a user of the vehicle. A processing circuit may verify the authenticity of the user's voice, confirm the authority of the user to operate the systems the vehicle, detect commands from the user, confirm receipt of the commands. And operate one or more systems of the vehicle responsive to the command. In another example, the cameras may track objects proximate to the vehicle and direct a beam of light from the projector light to illuminate or track the movement of one or more of the objects.

### Collision Detection

Many vehicles are equipped with some type of safety system, such as airbags. In the event of a collision, the safety equipment automatically operates to protect the passengers in the vehicle. Other vehicle systems, such as the steering system, the brake system, the suspension system and the drivetrain, may also be used to avoid or mitigate damage from a collision but must be operated by the driver and generally prior to the collision to provide any benefit.

In an example embodiment, a first vehicle includes a collision detector that detects potential imminent collisions. The collision detector determines that a collision is imminent a few seconds before the collision might occur. For example, as the first vehicle enters an intersection, the collision detector detects a second vehicle moving in a direction and at a speed that will result in a collision between the first and the second vehicles in a matter of seconds. Upon determining that a collision is imminent, the collision detector may control systems such as the steering system, the brake system, the suspension system and/or the drivetrain in such a manner to avoid the collision or to decrease potential harm to the passengers.

For example, upon detecting an imminent collision, the collision detector may control the steering system to turn the first vehicle entirely out of the path of the second vehicle. The collision detector may control the steering system and the drivetrain to direct the first vehicle away from the path of the second vehicle while accelerating the movement of the first vehicle to move out of the path faster. The collision detector may control the braking system and the drivetrain to change the orientation of the first vehicle with respect to the second vehicle so that the collision occurs primarily with the rear of the first vehicle and not with the front or the side of the first vehicle. The collision detector may control the systems of the first vehicle in any manner to avoid or mitigate potential harm from the collision.

### 1. Sound System

### 1.1 Speakers

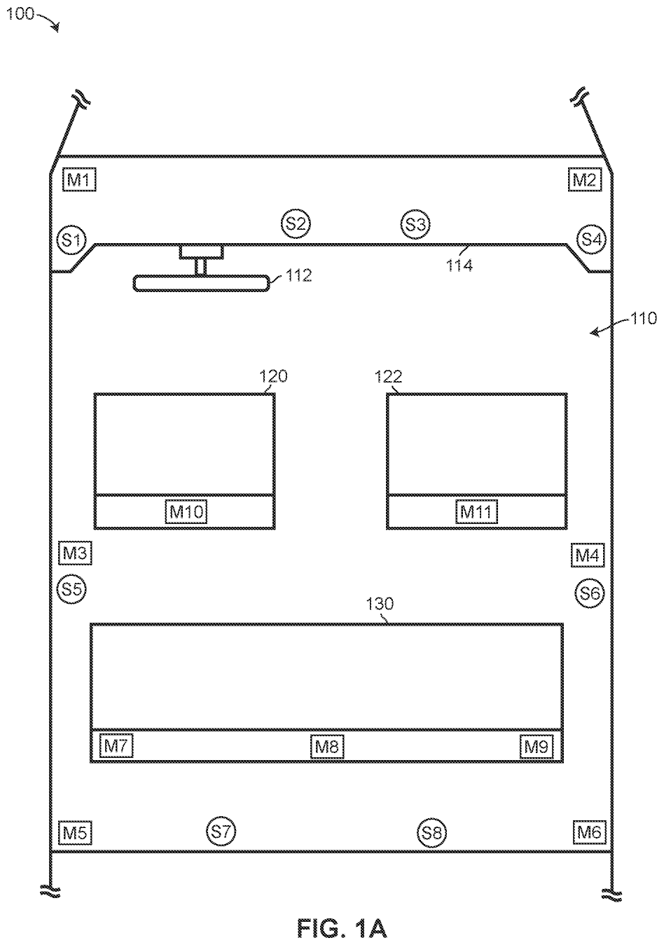

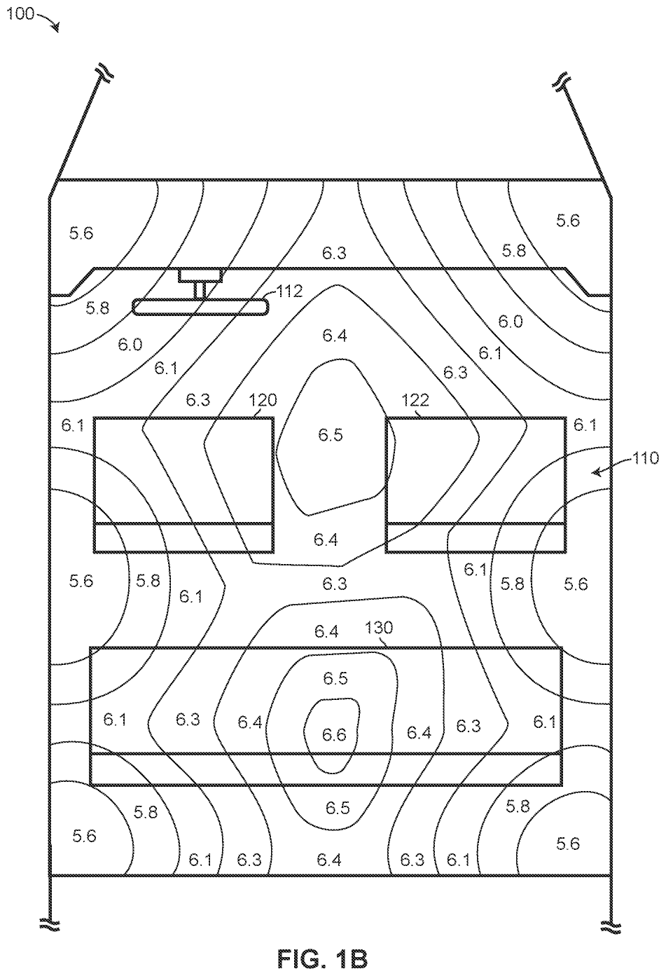

In an example embodiment of the sound system, as best shown in FIGS. 1-7, speakers S1-S8 are positioned at various locations inside the interior 110 (e.g., cabin) of the vehicle 100. The speakers provide sound to the occupants of the driver seat 120, the passenger seat 122 and the backseat 130. It is desirable to provide the sound at approximately the same volume to the occupants of the vehicle 100 regardless of the number of occupants and or objects positioned inside the interior 110 of the vehicle 100.

The speakers S1-S8 may be of any type. The speakers S1-S8 may be omnidirectional or directional. In an example implementation, the sound provided by a speaker may be directed in a particular direction, which direction may be changed from time to time. In another example implementation, the sound provided by a speaker is provided in a specific direction, which direction cannot be altered. The speakers S1-S8 may be configured to provide sound primarily in a specific range of frequency.

### 1.2 Microphones

In an example embodiment, as best shown in FIGS. 1-7, microphones M1-M11 are positioned at various locations inside the interior 110 of the vehicle 100. The microphones detect the sound received at their various respective locations. Each microphone is configured to detect the properties of the sound it receives, such as frequency, amplitude (e.g., volume, loudness), timbre, envelope, wavelength and phase. Data (e.g., information) regarding the sound captured by each microphone M1-M11 may be provided to a sound analyzer 720. In a situation such as sound in a vehicle, the volume and/or frequency of the sound are the properties most noticeable to the user.

A baseline (e.g., calibration) measurement of the sound levels (e.g., volume) inside the interior 110 of the vehicle 100 may be made while the interior 110 is empty (e.g., no passengers, no objects). The baseline measurement may include the properties of the sound detected by each microphone M1-M11. The results of the baseline measurement may be stored, for example in memory 740 as calibration data 742. The baseline measurement may include the properties of sound detected by each microphone M1-M11 under different conditions, such as different volume settings and/or different frequency ranges (e.g., mixer settings). The baseline measurement provides indicia of the properties of the sound that a microphone receives when the sound arrives at the microphone unobstructed.

The baseline measurement may be compared against the data collected by the microphones M1-M11 while there are occupants and/or object in the interior 110 of the vehicle 100. The current measurement of the sound received at each microphone M1-M11 may be compared to the baseline measurement at each microphone M1-M11 to determine whether the sound to any microphone is obstructed or altered. Comparison may be performed by the processing circuit 730. A change in one or more properties of the sound as detected by one or more of the microphones M1-M11 may indicate that the sound from one or more of the speakers S1-S8, as detected at the microphone M1-M11, is being obstructed (e.g., blocked, muffled, altered, filtered). A decrease in the volume of sound detected by a microphone is an indication that sound directed toward the microphone is obstructed.

### 1.3 Amplifier

The amplifier 710, as shown in FIG. 7, amplifies the volume of the sound provided by each speaker S1-S8. The amplifier 710 may further include an equalizer, a fader and/or a balancer to further modify the properties of the sound provided by the speakers S1-S8. The processing circuit 730 is configured to control the amplifier 710. The processing circuit 730 may control the amplifier 710 in accordance with the analysis performed by sound analyzer 720 in in comparison to the calibration data 742. The amplifier 710 may receive instructions from the processing circuit 730 to increase or decrease the volume, or to alter some other property of the sound, provided by any one or more speaker S1-S8, so the sound received by the microphones M1-M11 more closely matches the calibration data 742. The processing circuit 730 may store (e.g., record, remember) the present volume setting, or other property settings, of each speaker S1-S8. The processing circuit 730 may store the sound properties detected by sound analyzer 720 as a sound map, as further discussed below. The processing circuit 730 may provide present volume or other property settings information for each speaker S1-S8 to the sound analyzer 720.

### 1.4 Sound Analysis

The sound analyzer 720 analyzes the properties of the sound received by each microphone M1-M11. The processing circuit 730 may compare the properties of the sound received by each microphone M1-M11 to the sound properties recorded during the baseline (e.g., calibration) measurement. The processing circuit 730 may detect differences between the properties of the sound currently received by each microphone M1-M11 and the sound received by each microphone M1-M11 as recorded during the baseline measurement.

The processing circuit may prepare a sound map, as best shown in FIG. 1B, for characteristics of the sound identified by the sound analyzer 720. For example, in FIG. 1B, the processing circuit identifies each area of the interior 110 of the vehicle where the volume of the sound is the same. Similar maps may be prepared by the processing circuit to identify areas of the interior 110 where the frequency is the same, or any other property of sound. The processing circuit 730 may use a sound map of calibration data for comparison against a sound map of the sound currently present in the interior 110. The processing circuit 730 may compare sound maps to determine areas in the interior 110 where the sound differs from the baseline measurement. Sound maps may be stored in the memory 740 as sound map 744.

The sound map shown in FIG. 1B is a two-dimensional map of volume (e.g., intensity) of the sound in the interior 110. If the volume of the sound does not vary very much vertically in the interior 110, a two-dimensional map may be sufficient for comparisons. However, it is also possible for the processing circuit 732 construct a three-dimensional map of a sound characteristic in the interior 110. A three-dimensional map would have additional layers similar to the sound map of FIG. 1B that represent horizontal portions of the interior 110. A three-dimensional map would show the volumes of the interior 110 that share the same sound property.

The processing circuit 730 may use the differences identified by the comparison to determine one or more new sound property settings, in particular the volume setting, for each speaker 51-S8 so that as many microphones as possible receive the sound having properties, in particular volume, as recorded in the baseline measurement. For example, if the processing circuit 730 detects that the volume of the current sound received by any microphone M1-M11 is less than the volume of the sound recorded in the baseline measurement, the processing circuit 730 is configured to instruct the amplifier 710 to increase the volume of the sound provided by one or more speakers S1-S8 so the volume of the current sound received by the microphones M1-M11 is equivalent to the volume of the sound received in the baseline measurement. In other words, the processing circuit 730 may instruct the amplifier 710 to increase or decrease the volume of the sound provided by one or more speaker 51-S8 to compensate for objects and/or occupants that block or otherwise alter the sound received at any microphone M1-M11.

The processing circuit 730 is configured to instruct the amplifier 710 to change any property of the sound so that the present sound from the speakers S1-S8 is as close as possible to the sound in the baseline measurement. For example, the processing circuit 730 may instruct the amplifier 710 to change the phase of the sound for one or more speakers S1-S8 to compensate for phase alterations caused by an object in the interior of the vehicle 100.

In the case of adjusting the volume of the sound, although the processing circuit 730 attempts to adjust the volume provided by the speakers S1-S8 so that the current volume detected by the microphones M1-M11 is the same as in the baseline measurement, the sound from one or more speakers S1-S8 may be obstructed or altered in such a manner that is difficult, if not impossible, to adjust the volume of the other speakers to provide the same level of volume to each microphone M1-M11 as in the baseline measurement. The processing circuit 730 attempts to adjust the volume provided by each speaker S1-S8 so that the volume of the sound presently received at each microphone is as close to the baseline measurement as possible. The processing circuit 730 may further adjust the volume provided by each speaker S1-S8 so that the sound map of the present sound is as close as possible to the sound map of the baseline measurement.

The analysis performed by the processing circuit 730 may be accomplished by execution of a fixed program by the processing circuit 730 (e.g., microprocessor, signal processor). In an example embodiment, the algorithms performed by the sound analyzer 720 are stored in the memory 740 that is executed by the processing circuit 730. In another example embodiment, the algorithms executed by the processing circuit 730 are determined and controlled by artificial intelligence and/or machine learning.

Analysis performed by processing circuit 730 may be performed for each microphone M1-M11 individually. Analysis may be performed for groups of microphones together. Analysis may be performed for each speaker S1-S8 or groups of speakers together. Analysis may be performed for each speaker or groups of speakers with respect to each microphone M1-M11 individually or groups of microphones. The processing circuit 730 may graphically overlay the sound map of the current sound with the sound map of the baseline measurement. The processing circuit may iteratively instruct the amplifier 710 to alter characteristics of the sound, for example volume, until the sound map of the current sound matches, within a limit, the sound map of the baseline measurement. During each iteration, the processing circuit 730 may identify areas of difference between the current sound map and the sound map of the baseline measurement. The processing circuit 730 may iterate until the area, or volume, of the differences between the current sound map in the baseline sound map reaches a range of values.

For example, the processing circuit 730 may iteratively instruct the amplifier 710 to alter characteristics of the sound until the areas, or volumes, of difference between the current sound map and the baseline sound map fall within the range of 1% to 20%. For example, when the volume of the sound in only 15% of the area of the interior 110 differs from the volume of the sound in the baseline sound map, the processing circuit determines that the current sound map sufficiently matches the baseline sound map. When comparing sound maps, the areas around the seat 120, the seat 122 and the backseat 130 may be prioritized for matching. In other words, higher effort is expended by the processing circuit 732 match the current sound proximate to the seats to the baseline measurements.

### 1.5 In Operation

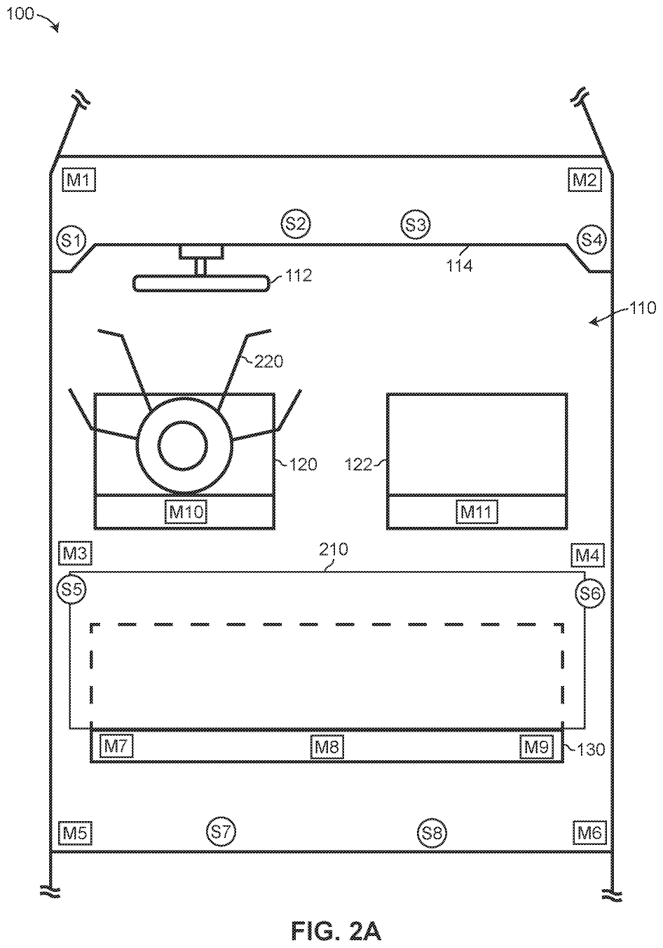

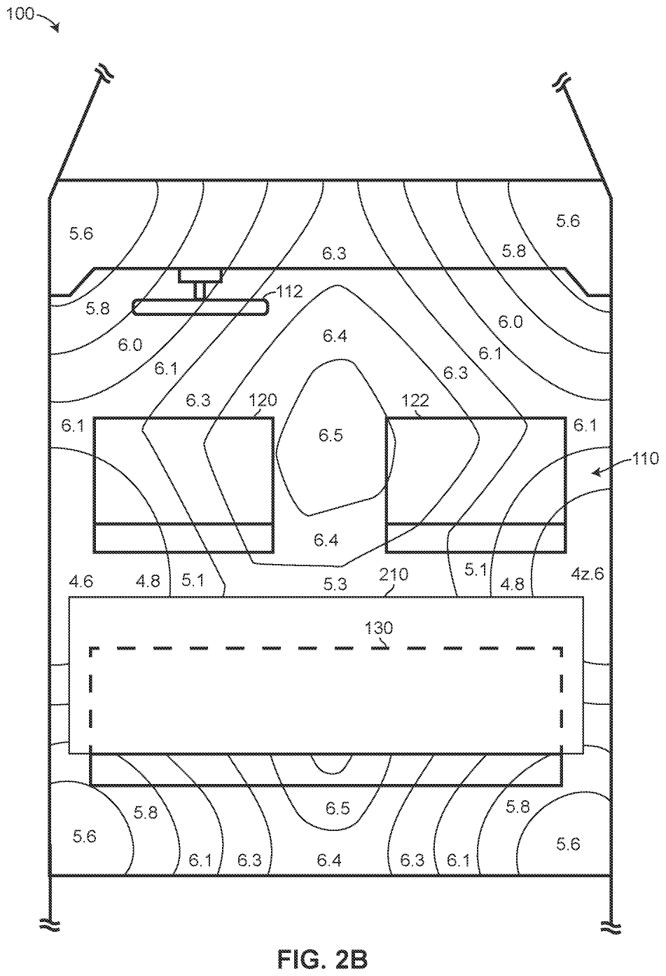

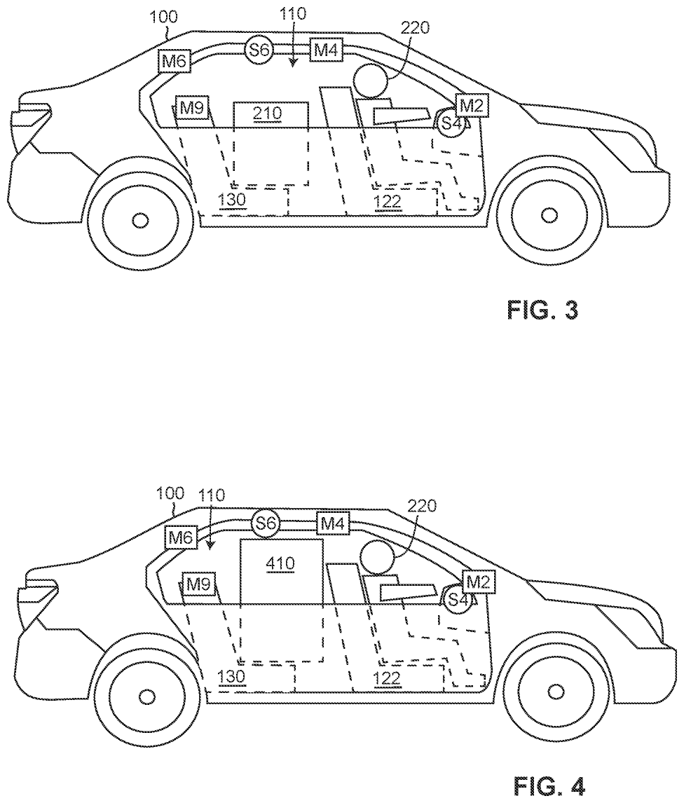

In the example situation as shown in FIGS. 2-3, the vehicle 100 carries the driver 220 and a box 210. However, as can be seen, in particular in FIG. 3, the box 210 does not block the sound from any speaker S1-S8 to any microphone M1-M11, so the sound analyzer 720 need not make any adjustments to the sound provided by the speakers S1-S8 to compensate for the presence of the box 210. The head of the driver 220 may block some sound from speaker Si to microphone M10, but the volume from speaker S5 may be adjusted to compensate.

In the example situation shown in FIG. 4, the box 410 goes across the entire backseat 130 from door-to-door, nearly reaches the ceiling of the interior 110, and nearly reaches the back of the driver seat 120 and the passenger seat 122. Box 410 interferes with the propagation of sound from the speakers S5-S8 to microphones M1-M4 and M10-M11, and the propagation of sound from speakers S1-S6 to microphones M5-M9. The processing circuit 730 detects the interference caused by the box 410. The processing circuit 730 adjusts the volume of the speakers S5-S8 and S1-S4, via the amplifier 710, so that each microphone M1-M11 detects about same volume of sound as detected during the baseline measurement; however, due to the size and the material of the box 410, there is likely no setting for the speakers S1-S8 and S1-S4 which will compensate for the interference caused by the box 410. The processing circuit 730 will attempt to compensate as much as possible to reach the baseline measurement, but likely will not be able match the base measurement for all of the microphones M1-M11.

In another example situation with respect to FIG. 4, the processing circuit 730 instructs the amplifier 710 to provide sound from one or more speakers and measures the sound detected by one or more microphone at a time. Analyzing the propagation of sound from one or more speakers to specific microphones enables the processing circuit 730 to determine the volume inside the interior 110 that alters the sound. In other words, the processing circuit 730 is configured to determine the volume (e.g., size) of the box 410 (e.g., the obstruction) and its position in the interior 110. Having information regarding the volume of the obstruction, the processing circuit 730 is configured to determine that the sound from the speakers S5-S7 is nearly completely obstructed. The processing circuit 730 may also generate a sound map that identifies the area of obstruction in the interior 110. The sound analyzer 720 may further determine that sound cannot be delivered to the occupants, if any, of the backseat 130. Accordingly, the sound analyzer 720 adjusts the speakers S1-S4 to provide sound to the driver seat 120 and the passenger seat 122 as close to the baseline measurements as possible and ignores any adjustments for the speakers S5-S8.

A sound map of the interior 110 with the box 210 on backseat 130 is shown in FIG. 2B. The presence of the box 210 blocks all sound arriving from speakers S1-S6 from arriving at microphones M5-M9. The remaining speakers S1-S4 cannot fully compensate for the loss of sound blocked by the box 210. The sound arriving from speakers S7-S8 two microphones M7-M9 is unaffected by the presence of the box. In an example embodiment, upon detecting such a large obstacle, the processing circuit 730 attempts to compensate the sound in the area of the seat 120 and the seat 122 as opposed to the entire cabin.

The sound system may include additional speakers and microphones that are used to determine the volume of an obstruction but are not used primarily to provide sound to the occupants of the vehicle. For example, speakers and/or microphones may be positioned indoors, in the back of the driver seat 120 and/or the passenger seat 122, under the dashboard 114, in or near the floors of the vehicle and/or at additional locations in the ceiling (e.g., headliner) of the interior 110. These additional speakers may have less dynamic range, be highly directional, or have some other limitation that makes it unsuitable for providing sound to the occupants but are useful for determining the location and/or volume of an obstruction. The information regarding location and/or volume of an obstruction may be used by the processing circuit 730 to determine if the sound provided by the speakers S1-S8 can compensate for the loss of sound (e.g., absorption) caused by the obstruction. The additional speakers and microphones may aid in producing a three-dimensional sound map of the interior 110.

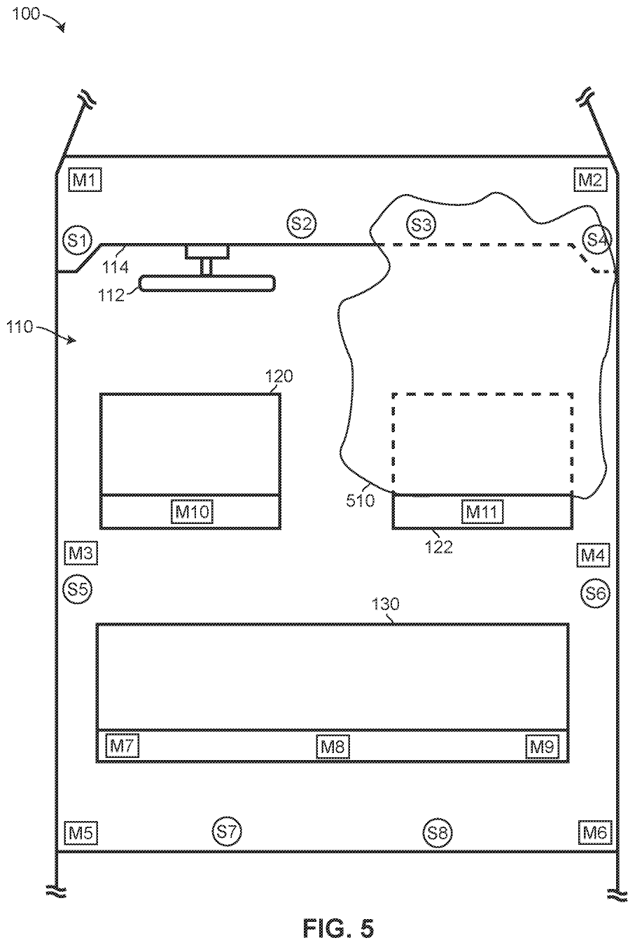

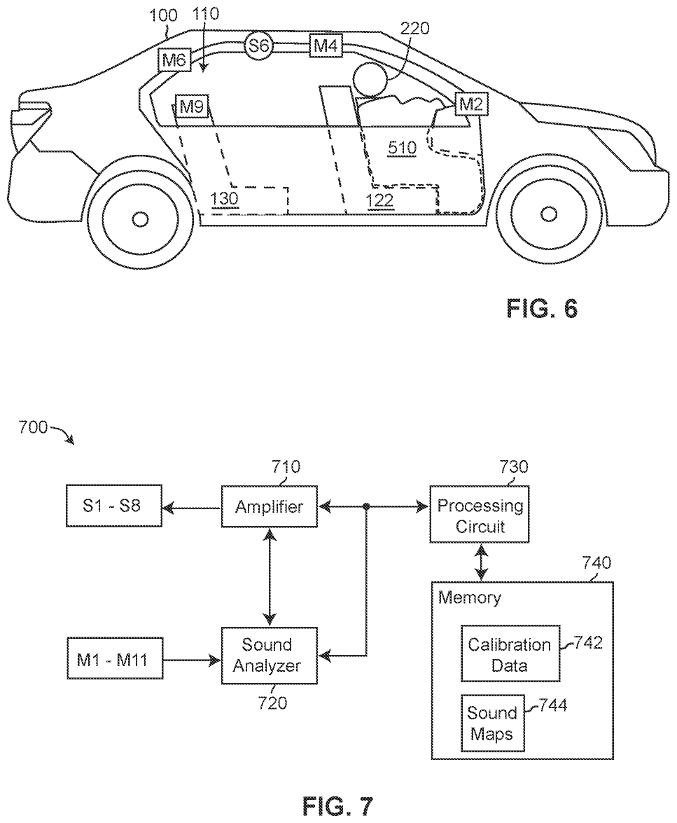

In another example situation as shown in FIGS. 5-6, a pile of stuff 510 (e.g., yarn, cloth, clothing) fills passenger seat 122 and even covers speakers S3 and S4. Although the processing circuit 730 attempts compensate for the interference caused by the pile of stuff 510, since the pile covers S3 and S4, there is likely no setting for the other speakers that will compensate for the loss of sound from the speakers S3 and S4. It is likely that the volume of the sound from the speakers S1, S2 and S5 may be increased to provide the base measurement at microphones M1 and M10. It is likely that the volume of the sound from the speakers S5-S6 may be adjusted to provide the base measurement at microphones M7-M9 and M11. However, it is likely that the loss of the output from the speakers S3 and S4 cannot be fully replaced (e.g., compensated for), so the volume of the sound at some microphones may not be equivalent to the base measurement.

In another example embodiment, light sources (e.g., lasers) and light detectors are used to determine the location and/or volume of an obstruction. A light source may provide a beam of light to a light detector. If the light from the light source does not arrive at the light detector, the processing circuit 730 knows that something along the path of the light is obstructing the light. In another example embodiment, cameras may take pictures of the interior 110 of the vehicle 100. The images of the interior are compared to images of the interior of the vehicle while empty to detect the location and/or volume of an obstruction. The processing circuit 730 uses information regarding the location and/or the volume of an obstruction to adjust the sound system to provide sound as close to the base measurement as possible.

### 2. Light Bars

### 2.1 Roof-Proximate Light Bars

In an example embodiment, the vehicle 800 includes a roof 810, a light bar 820, a windshield 830, and an interior 840. The light bar 820 is positioned in the interior 840 of the vehicle 800 behind (e.g., inside of) the windshield 830 proximate to the roof. The light 822 emitted from the light bar 820 shines (e.g., passes) through the windshield 830 and is visible on an exterior of the vehicle 800. The light 822 emitted from the light bar 820 shines in a forward direction with respect to the vehicle 800 to provide light in front of the vehicle 800. The light bar 820 is also positioned under the headliner 930 of the vehicle 800. The headliner 930 of the vehicle 800 completely covers the light bar 820 so that the light bar 820 is not visible in the interior 840 of the vehicle 800.

In another example embodiment, the vehicle 800 includes the light bar 910. The light bar 910 is positioned in the interior 840 of the vehicle 800 behind (e.g., inside of) the rear window 920 proximate to the roof. The light bar 910 emits light 912. The light 912 shines through the rear window 920 to be visible on an exterior of the vehicle 800. The light 912 shines in a rearward direction, with respect to the vehicle, to provide light behind the vehicle 800. The light bar 910 is positioned under the headliner 930. The headliner 930 completely covers the light bar 910 so that the light bar 910 is not visible in the interior 840 of the vehicle 800.

In another example embodiment, the headliner 930 includes a reflective layer between the headliner and the light bar 820/910 to direct the light 822/912 through the windshield 830/rear window 920 and away from the vehicle 800. The reflective layer reduces the amount of light 822/912 that enters the interior 840 of the vehicle 800. The reflective layer redirect any light that reflects from the inner surface of the windshield 830/rear window 920 back out the windshield 830/rear window 920. In another example embodiment, the inside of the windshield 830/rear window 920 proximate to the light bar 820/910 includes a coating that reduces reflection of the light 822/912 from the windshield 830/rear window 920 into the interior 840 of the vehicle 800. In another example embodiment, the headliner 930 is formed of a material that absorbs the heat that may be produced by the light bar 820/910.

In another example embodiment, the headliner 930 includes a heating/cooling element proximate to the light bar 820/910 to control the temperature of the light bar 820/910. The heating/cooling element may be controlled by a thermostat that detects a temperature of the light bar 820/910 and/or the temperature of the headliner 930 proximate to the light bar 820/910. Controlling the temperature of the light bar 820/910 may operate to improve the performance of the light bar 820/910. In another example embodiment, the headliner 930 proximate to the light bar 820/910 removably couples to the light bar 820/910. The headliner 930 proximate to the light bar 820/910 may be removed for easy access to the light bar 820/910 for servicing.

In another example embodiment, headliner 930 forms a cavity 940 and 950 between the roof 810 and the windshield 830 and the rear window 820 into which the light bar 820 and the light bar 910 respectively are removably inserted via the passenger-side or the driver-side. While the light bar 820/910 is positioned in the cavity 940/950, the headliner 930 supports and holds the light bar 820/910 in position. The light bar 820/910 may be pulled from the cavity 940/950 via an opening on the passenger-side or the driver-side for servicing or replacement.

### 2.2 Body Light Bars

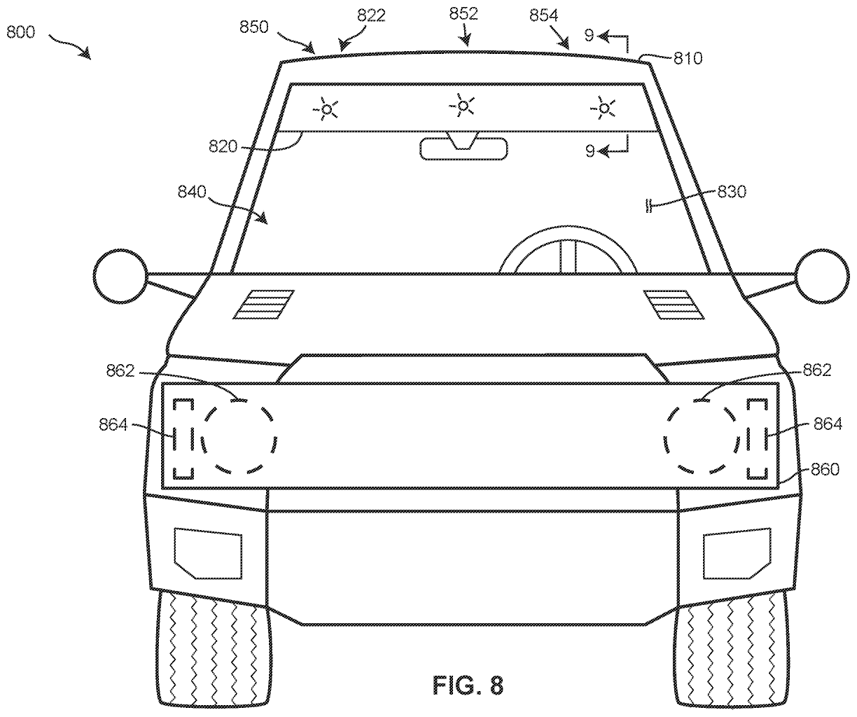

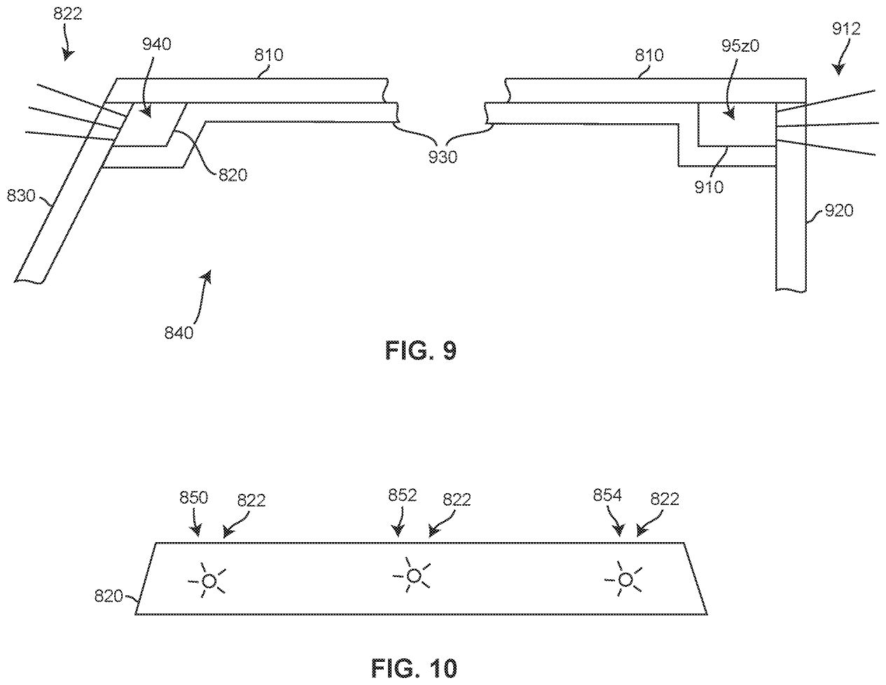

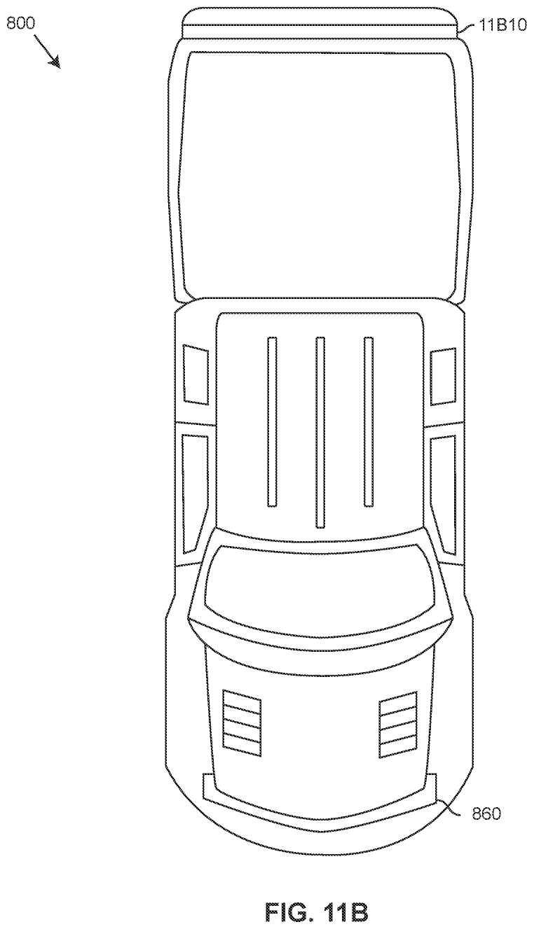

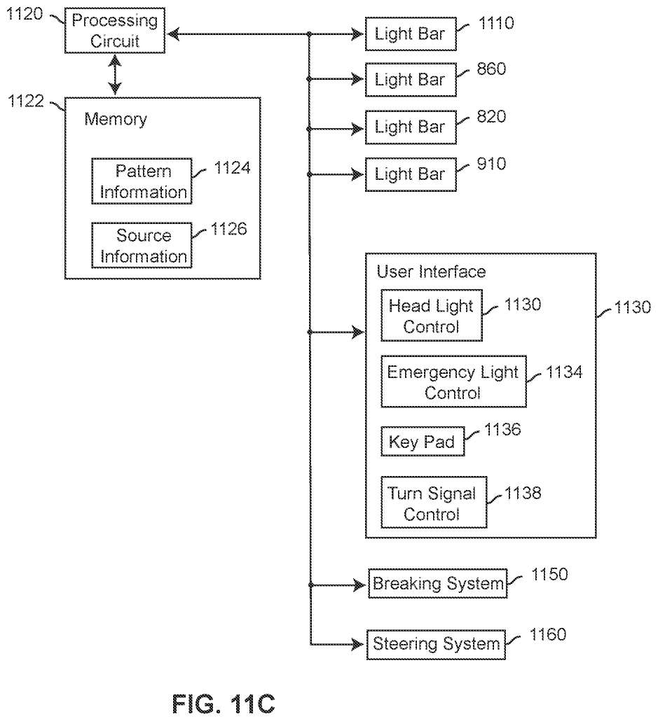

In another example embodiment, the vehicle 800 includes a light bar 860, best seen in FIGS. 8 and 11B, mounted to a front portion of the body of the vehicle 800. The light emitted from the light bar 860 travels in the forward direction with respect to the vehicle 800 to provide light in front of the vehicle 800. As best shown in FIG. 8, a portion of the light bar 860 is mounted in the position where headlights, turn signals and/or daylight running lights would be positioned. In other words, the light bar 860 covers the area where the forward-facing lights would be positioned. In this example embodiment, portions of the light bar 860 are configured (e.g., programmed) to emit light in the same manner as would be emitted by the headlights, the turn signals and/or the daylight running lights. In other words, a portion of light bar 860 is configured to emulate the operation of headlights, the turn signals and/or the daylight running lights.

For example, the light sources in the area 862 and in the area of 866 of the light bar 860 are configured to emit light with the intensity (e.g., brightness), color and with the field-of-illumination (e.g., vertical field-of-illumination, horizontal field-of-illumination) of head lights. The processing circuit 1120 that controls light bar 860 may cooperate with the headlight switch and the headlight brightness switch to control the light sources in the area 862 and in the area of 866 to illuminate or to turn off the light sources in the area 862 and in the area 866 to emulate the operation of headlights. Additional areas across the width of the light bar 860 may also be controlled to emulate headlights thereby allowing the vehicle 800 to have more than two headlights. In an example embodiment, the entire area of the light bar 860 between the area 862 and the area 866 operates as a headlight to illuminate in front of the vehicle 800.

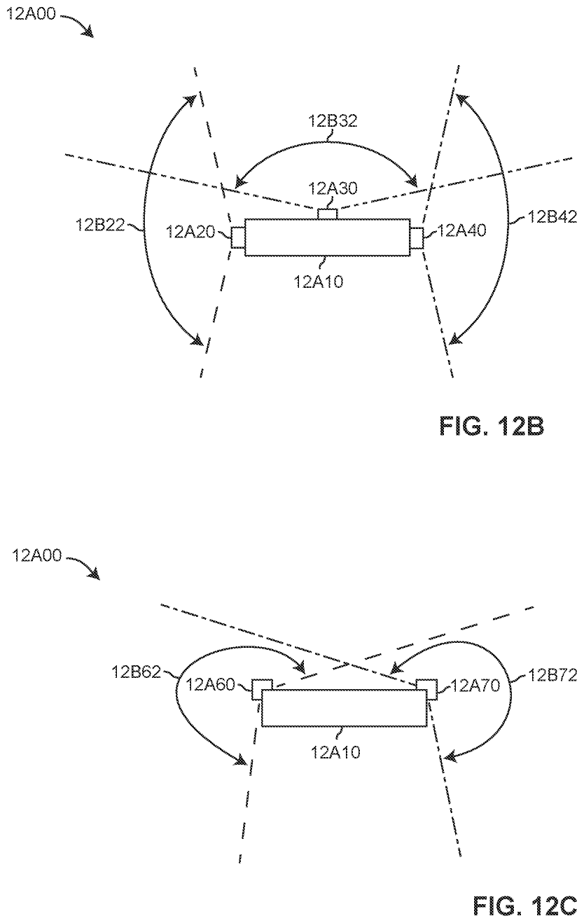

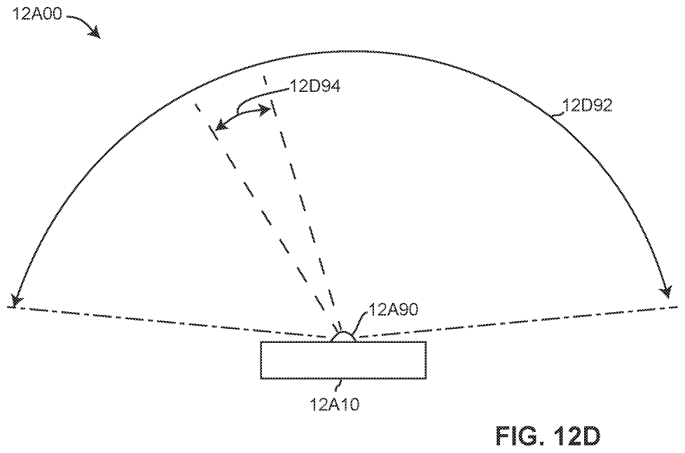

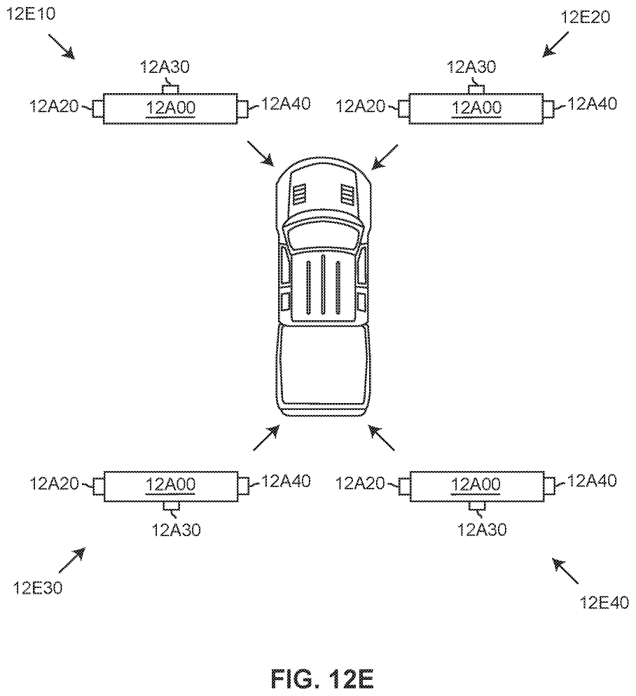

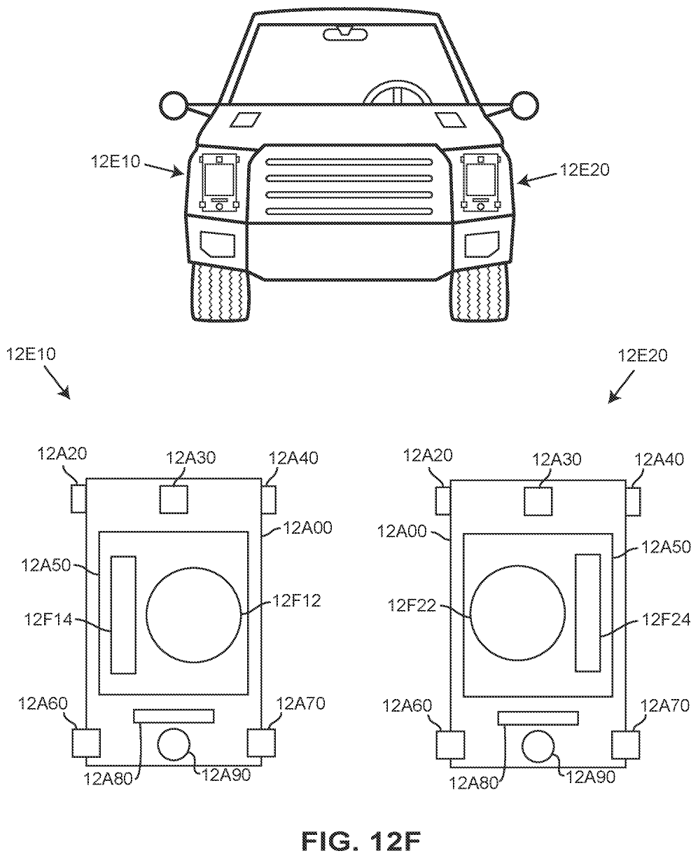

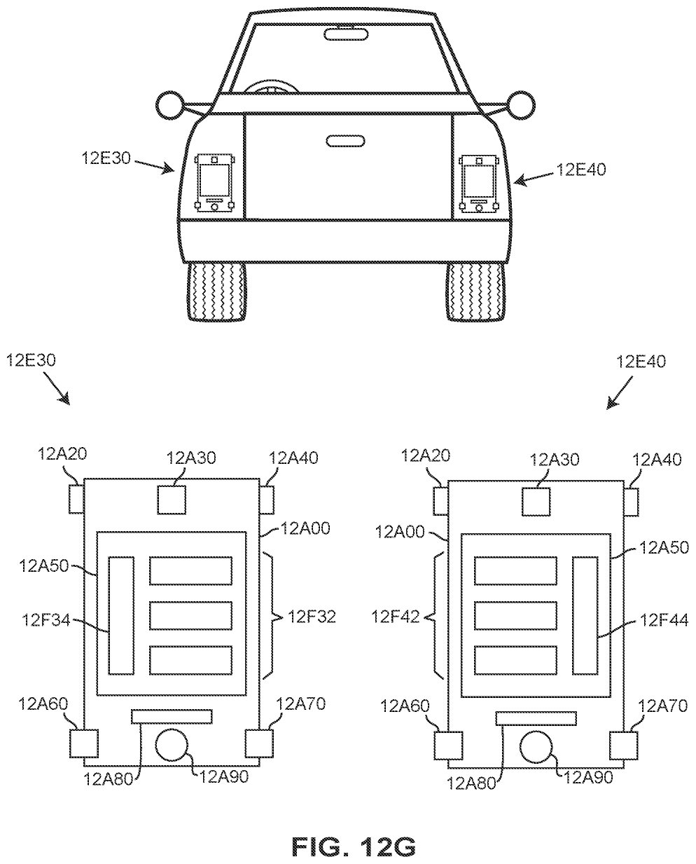

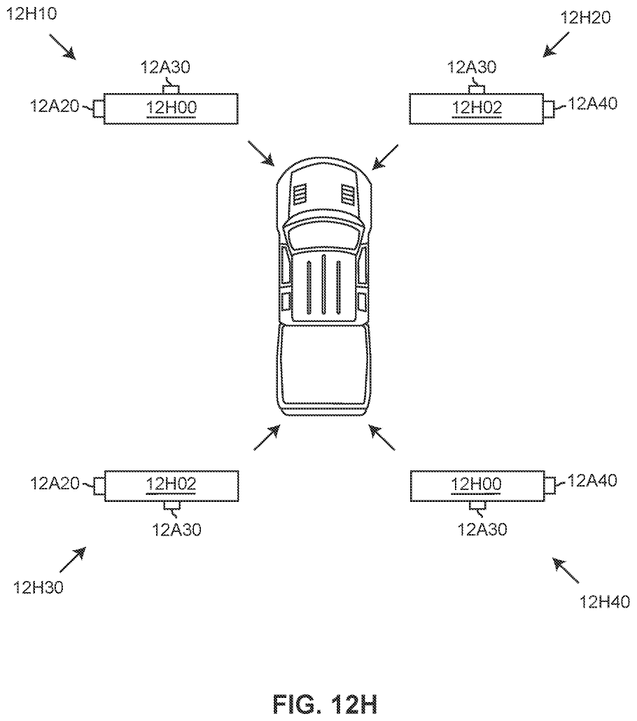

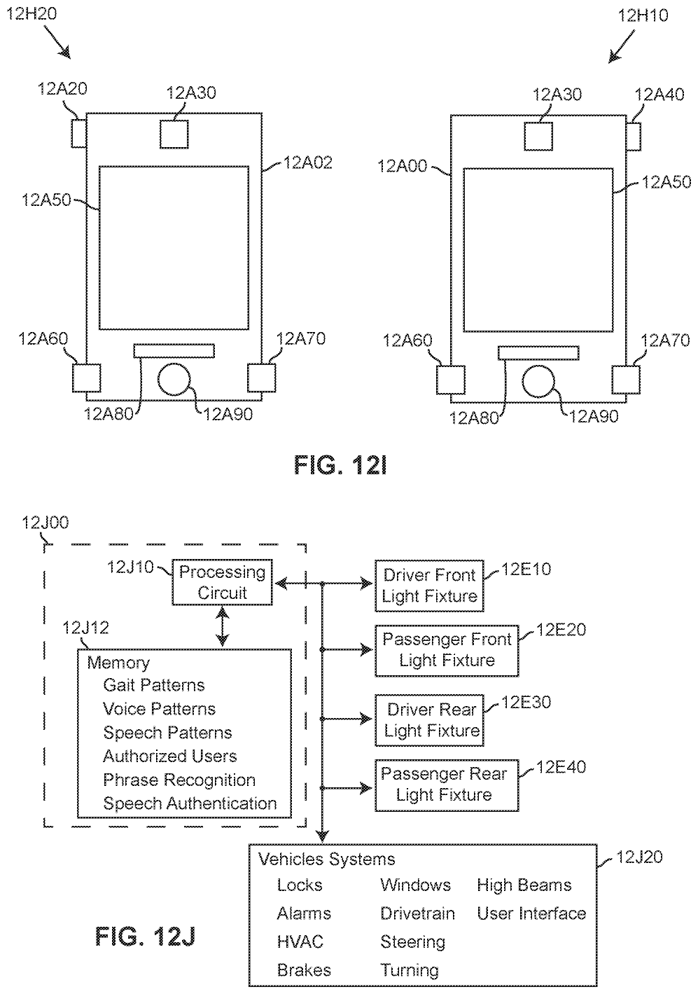

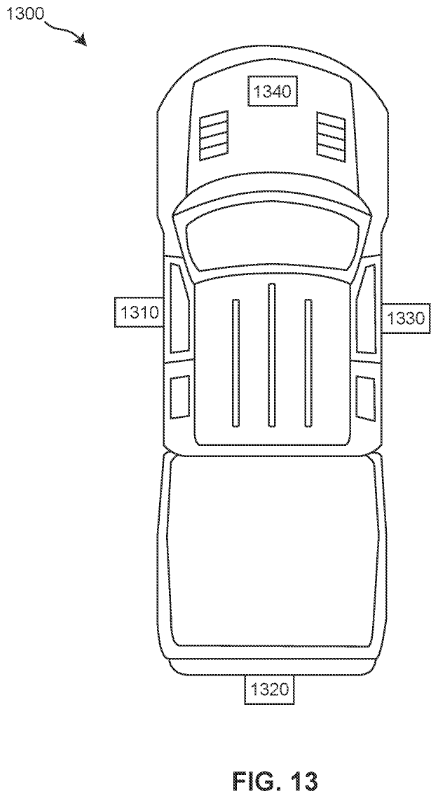

The light sources and the area 864 and the area 868 of the light bar 860 are configured to emit light in the intensity, color and with the field-of-illumination of turn signals. The processing circuit 1120 that controls the light bar 860 may cooperate with a turn indicator switch and the steering system to illuminate or to turn off the light sources in the area 864 and the area 868 to emulate turn signals. The light bar 860 may wrap around the sides (e.g., edges) of the vehicle 800, as best seen in FIG. 12B, to provide light sources on the sides of the vehicle 800. The portions of the light bar 860 on the sides of the vehicle 800 may emulate turn signals. The portions of the light bar on the sides of the vehicle 800 may provide light for visibility to the sides and rear of the vehicle 800. Light sources of portions of the light bar 860 may be illuminated during the daylight to emulate daylight driving lights.

In another example embodiment, best seen in FIG. 11B, the vehicle 800 includes a light bar 11B10 mounted to a rear portion of the body of the vehicle 800. The light emitted from the light bar 11B10 travels in a rearward direction with respect to the vehicle 800 to provide light in the rear of the vehicle 800. A portion of the light bar 11B10 is mounted in the position where taillights, turn signals and brake lights would be positioned. In other words, the light bar 11B10 covers the area where the rearward-facing lights would be positioned. In this example embodiment, portions of the light bar 11B10 are configured to emit light in the same manner as would be emitted by the taillights, the turn lights and the brake lights.

For example, light sources of the light bar 11B10 in the area of where the brake lights would be positioned are configured to emit light in the intensity, color and with the field-of-illumination of taillights and brake lights. The light bar 11B10 cooperate with the headlight switch, the braking system and the steering system to illuminate and to turn off light sources of the light bar 11B10 to emulate taillights, brake lights and turn signals. The light bar 11B10 may wraparound the sides of the vehicle 800 to provide light sources on the sides of the vehicle 800 so the light sources may be turned on and off to emulate turn signals and/or to provide light to increase visibility to the sides and rear of the vehicle 800.

### 2.3 Light Sources

The light bars may use any type of technology for generating and emitting light from a light bar (e.g., 820, 860, 910, 11B10). In an example embodiment, the light bar includes a plurality light emitting diodes (e.g., LEDs) for generating and emitting light. The LEDs may be positioned at any location on the light bar. The LEDs may be positioned evenly across the length and the height of the light bar. In an example embodiment, the LEDs are arranged in rows and columns across the light bar. The LEDs may be controlled by the processing circuit 1120. The processing circuit 1120 may control an LED to cause the LED to illuminate, to turn off the LED so it no longer provides light, to provide light of particular color and/or provide light at a particular intensity when illuminated. The processing circuit 1120 may control an LED to turn it on and off in accordance with a pattern (e.g., interval). The processing circuit 1120 may control the LEDs individually or in groups. The processing circuit 1120 may control the LEDs to illuminate to form patterns, such as words or symbols. The processing circuit 1120 may control the LEDs to form words or symbols that are static, in that they remain in the same place on the light bar. The processing circuit 1120 may control the LEDs to form words or symbols that are dynamic, in that they move across (e.g., up, down, diagonally) the light bar.

In another example embodiment, the light bar includes a plurality of LEDs in combination with other types of light sources (e.g., halogen, solid-state lighting, fluorescent, incandescent, high-intensity discharge). The other types of sources may be positioned at locations on the light board where headlights, turn signals, taillights and/or brake lights are emulated. The light sources of the light bar 820, 860, 910 and 11B10 may provide light of any color and any intensity less than or equal to a maximum intensity.

### 2.4 Control

As discussed above, the light bar 820, 860, 910, 11B10 may be controlled by the processing circuit 1120. In particular, the processing circuit 1120 may control which light sources are turned on and which light sources are turned off at a particular time. The processing circuit 1120 has access to source information 1126 regarding the light sources of the light bars. The source information 1126 includes the location of each light source with respect to the area of the light bar. The source information 1126 may further include information regarding the color of light generated, the minimum intensity and the maximum intensity of each light source.

The processing circuit 1120 may have further has access to pattern information 1124. Pattern information 1124 includes information regarding the settings for the light sources of the light bar to produce light having a particular pattern. The pattern information 1124 includes information regarding the areas of a light bar that must be controlled to perform a particular function. For example, the pattern information 1124 identifies the area 862, the area 866, the area 864 and the area 868 as the areas of the light bar 860 that emulate the operation of the headlights, the turn lights and the daylight running lights. The pattern information 1124 further identifies areas of the light bar 11B10 that emulate the operation of the taillights, the brake lights and the turn lights. In the case of the taillights and the brake lights, the pattern information 1124 would inform the processing circuit 1120 that the area for emulating the taillights and the brake lights are the same areas, but that the intensity of the light sources in those areas differ according to whether the brakes are or are not applied. The pattern information 1124 would inform the processing circuit 1120 of the intensity for emulating brake lights as opposed to the intensity for emulating taillights. Further, the pattern information 1124 would inform the processing circuit 1120 whether the yellow lights that indicate a wide vehicle should be illuminated and if so, where on the light board. Further, the pattern information 1124 would identify the areas of a light bar that may be used to display user provided patterns, such as words or symbols. In another example embodiment, the badge of the manufacturer of the vehicle may be displayed on the light bar.

The processing circuit 1120 produces the signals to directly or indirectly control the light sources of the light bar 820, 860, 910, 11B10. In an example embodiment, the processing circuit 1120 provides electrical signals to control the illumination of the light sources of the light bar 820, 860, 910, 11B10. In another example embodiment, the processing circuit 1120 prepares a pattern buffer for each light bar 820, 860, 910, 11B10 and the light sources are controlled by signals from the pattern buffer. The light bar accesses its respective pattern buffer and illuminate or to turn off light sources in accordance with the instructions of the pattern buffer.

In an example embodiment, the processing circuit 1120 receives information from a user interface 1130, a braking system 1150 and a steering system 1160. The processing circuit 1120 controls the light sources of the light bar 820, 860, 910, 11B10 in accordance with the information received from the user interface 1130, the braking system 1150 and the steering system 1160. For example, when the user operates the headlight control 1132 to turn the headlights on or off, the processing circuit 1120 accesses the pattern information 1124 to determine which light bar emulates the headlights and the areas of the light bar that perform the emulation. The processing circuit 1120 then illuminates or turns off the light sources associated with the area 862 and the area 866 in accordance with the headlight control 1132.

When the user operates the turn signal controls 1134, the processing circuit 1120 accesses pattern information 1124 to determine which light bars display turn signals and areas of the light bars that emulate the turn signals, whether they be left or right turn signals. In accordance with the turn signals, the processing circuit 1120 illuminates the light sources that emulate the turn signals on the appropriate light bars. For example, for a right turn, the processing circuit 1120 illuminates the light sources in the area 868 of the light bar 860 as a flashing signal of the appropriate color. A similar area on the right-hand side of the light bar 11B10 would also be illuminated to flash the appropriate color. Once the turn is completed, the processing circuit 1120 receives a signal from the steering system 1160 that the turn has been completed, so the processing circuit 1120 causes that the light sources in the area 868 cease flashing. If the headlights have been turned on, the light sources in the area 868 may remain illuminated to a lesser intensity to perform the role of a side marker light.

The processing circuit 1120 uses information from the braking system 1150 to determine each time the user operates the brakes. Each time the processing circuit 1120 gets information that the user is operating the brakes, the processing circuit 1120 accesses the pattern information 1124 and/or the source information 1126 to determine which areas of the light bars must be illuminated to emulate the brake lights. Each time the processing circuit 1120 receives information that the user has ceased operating the brakes, the processing circuit 1120 accesses the pattern information 1124 and/or the source information 1126 to determine which light sources must be turned off, if the taillights are not on, or which light sources must have their intensity reduced to the level that emulates a taillight.

The user may use a keypad 1136 to select a symbol for display on a light bar (e.g., 820, 860, 910, 11B10). Patterns for common symbols may be stored in pattern information 1124. The processing circuit 1120 may use the pattern for the symbol and the source information 1126 to determine where the symbol may be displayed on a light bar. A user may use the keypad 1136 to enter information for a custom symbol. Upon receiving the custom symbol information, the processing circuit 1120 may determine that the symbol is not in the pattern information 1124. The processing circuit 1120 may use the source information 1126 to determine the light sources that need to be illuminated on a light bar to display the custom symbol. The processing circuit 1120 may store a pattern for the custom symbol in the pattern information 1124 for future use. The processing circuit 1120 may then display the custom symbol in an appropriate area on the appropriate light bar. A user may specify the light bar upon which a symbol should be displayed.

The light bar 820, 860, 910 and 11B10 may present words legible to a human being. The light bar 820, 860, 910 and 11B10 may present words legible to a human being viewing the words in a mirror. A user may specify one or more words for display via keypad 1136. The processing circuit 1120 uses the source information 1126 and the pattern information 1124 to determine the area of a light bar where the text may be displayed. If the headlights are supposed to be on, the words cannot be displayed in the area 862 and the area 866 of the light bar 860. Further if the vehicle is being driven, text cannot be displayed in the area where the turn signals (e.g., 864, 868), the taillights or the brake lights are emulated on the light bar 860 or the light bar 11B10. The words may be presented as stationary or if the length of the text is greater than the area available for display, the processing circuit 1120 may scroll the text across a light bar. The user may specify the color for the text and/or whether or not it is to flash. The user may further specify the scrolling speed.

The LEDs used in the light bars may provide light in a particular direction. In an example embodiment, one end of the LED is in its light in a beam that travels a straight line away from the LED. The light from the LED does not spread in a spherical or semi-spherical pattern. In this example embodiment, the LEDs are positioned with respect to the light bar 820, 860, 910 and 11B10 so that the light from each LED travels in a direction that is nearly perpendicular to the plane of the light bar 820, 860, 910 or 11B10. In another example embodiment, the LEDs are positioned at an angle with respect to the light bar 820, 860, 910 or 11B10 so that the light is directed at a slight downward angle toward the ground. Headlights in a conventional vehicle are positioned with respect to the ground so that the beam of light emitted from the headlight is directed toward the surface of the road and not into the eyes of oncoming traffic. The LEDs are similarly positioned so that the light from the LEDs is directed downward as opposed to parallel with the road or upward with respect to the road.

In another example embodiment, the light bar includes one or more lenses or optical devices for focusing or directing the light generated by the light sources. In particular, the light bar includes lenses positioned in the areas of the light bar where the headlights, taillights, brake lights and/or turn lights are emulated. For example, light bar 860 may include lenses positioned over the light sources in the area 862, the area 866, the area 864 and the area 868. The lenses may focus the light generated by the light sources of those areas to better form a beam. The lenses may focus the light from the light sources to establish a been having horizontal field-of-illumination and/or a vertical field-of-illumination. The lenses make direct the light from the light sources in a particular direction. For example, the light that emanates from the light sources in the area 862 and the area 866 must be directed downward toward the road so as not to shine in the eyes of oncoming traffic. The lenses May be adjustable to permit the light to be directed downward for a normal beam and slightly upward for a high beam. Lenses in the area of 864 and 866 must direct the light to emulate a turn signal. Lenses on light bar 11B10 direct the light from the areas of the light bar 11B10 to emulate brake lights, taillight and turn lights.

The light bars, in particular the light bar 860 and 11B10, are covered with a protective material to protect the light sources from the elements. A lens may be integrated into the protective material. The protective material may form a lens that covers the entire area of the light bar to focus and/or direct the light from the light sources equally. The protective material and/or the lenses may be formed of a material such as glass or plastic. In an example embodiment, the light bars include a protective cover in addition to material that has a lens like shape over particular areas such as the area 862, the area 866, the area 864 and the area 868. The lenses further focus the light from the light sources in those areas. The lenses may preclude the light sources in those areas from being used for anything other than emulating headlights, taillight, brake lights, turn lights and/or daytime running lights.

In another example embodiment, the protective material over the area 862, the area 866, the area 864 and the area 868 may be altered in shape by an electro-mechanical device (e.g., solenoid, actuators) to form the lens that focuses the light from the light sources. For example, one or more solenoids may push or pull on the material that covers the light bars, and in particular the material over the areas were lights are emulated (e.g., 862, 866, 864, 868) to cause a material to assume a concave, convex or other shape. As the light from the light sources strikes the material, the shape of the material focuses the light from the light sources as it passes through the material and away from the vehicle. When there is no need to emulate a vehicle light, the electro-mechanical devices deactivate so that the material covering the light sources is no longer shaped to focus the light. Accordingly, the portions of the light bar used to emulate vehicle lights may be used to display other symbols or text without distortion or focusing.

In another example embodiment, electrode mechanical devices move lenses from a stowed position that does not cover the light sources to a deployed position that does cover the light sources in the areas were lights are emulated. In this example, a lens for headlight may be stored in a cavity in or behind the light bar. When the lights are turned on, the electromechanical devices move the lens from the cavity to a position between the protective cover and the light sources. The lens focuses and or directs the light from the light sources before it passes through the protective cover of the light bar. The headlights are turned off, the electromechanical devices move the lens back into the cavity.

In another example embodiment, pneumatic pressure may be used to shape the material over the light sources that emulate vehicle lights. For example, the light sources that emulate vehicle lights may be surrounded by an enclosure that seals to the material that covers the light sources. The air pressure in the enclosure may be increased or decreased to push the material over the light sources outward or to suck the material inward to form the material into a shape that focuses the light from the light sources. When that area of the light bar is not emulating a vehicle light, the air pressure is decreased, the material over the light sources becomes flat and thereby does not focus the light but allows other patterns to be displayed in the same area of the light bar without distortion.

In an example embodiment, the vehicle 800 includes only the light bar 820. In another example embodiment, the vehicle 800 includes only the light bar 860. In another example embodiment, the vehicle 800 includes at least one and up to all of the light bar 820, 860, 910 and 12B10. The processing circuit 1120 may control all of the light bars regardless of number.

In another example embodiment, the material that covers the light sources is electrically tunable. When the light bar needs to emulate the headlights, the taillight, the brake lights, the turn lights or the daylight running lights, the material over the areas (e.g., 862, 864, 866, 860) that emulate lights is electrically tuned (e.g., controlled) so that the light from the light sources is focused into a beam by the electrically tuned material over the area. The material over the area (e.g., 862, 864, 866, 860) may be electrically controlled to focus the light from the light sources into a beam that has the desired characteristics. For example, the light from the light sources that emulate a headlight may be focused into a beam that shines downward toward the road. The light from the light sources that emulate a brake light may be focused to shine directly out from the light bar so that the light may be seen at a distance.

When the light bar does not need to emulate any of the lights, such as when it is being used to display text, the material that covers the areas of the emulated light sources is not electrically tuned, so the light from the light sources is not focused into beams. Because the light from light sources is not focused into beams at any place, the entire area of the light bar may be used to display text that is legible.

### 2.5 Traffic Related Light Patterns

The light sources of the light bar 820, 860, 910 and 11B10 may be arranged on the light bar in any manner to facilitate the formation and display of patterns. In an example embodiment, as discussed above, the plurality of LEDs is arranged along rows and columns to provide a grid of light sources. The processing circuit may control any number of LEDs to illuminate or not illuminate the LEDs to produce the pattern. Patterns may include the patterns needed to emulate headlights, taillights, brake lights, turn lights, and/or daylight running lights. A pattern may specify a color and/or an intensity for each LED needed to produce the pattern. For example, the LEDs in the area 862 and the area 866 are illuminated to generate a white light to emulate headlights. The LEDs in the area 864 and the area 868 are illuminated to generate an orange light that blinks (e.g., flashes) while the turn indicator switch is turned on and that turn off when the steering system 1160 indicates that the turn has been completed.

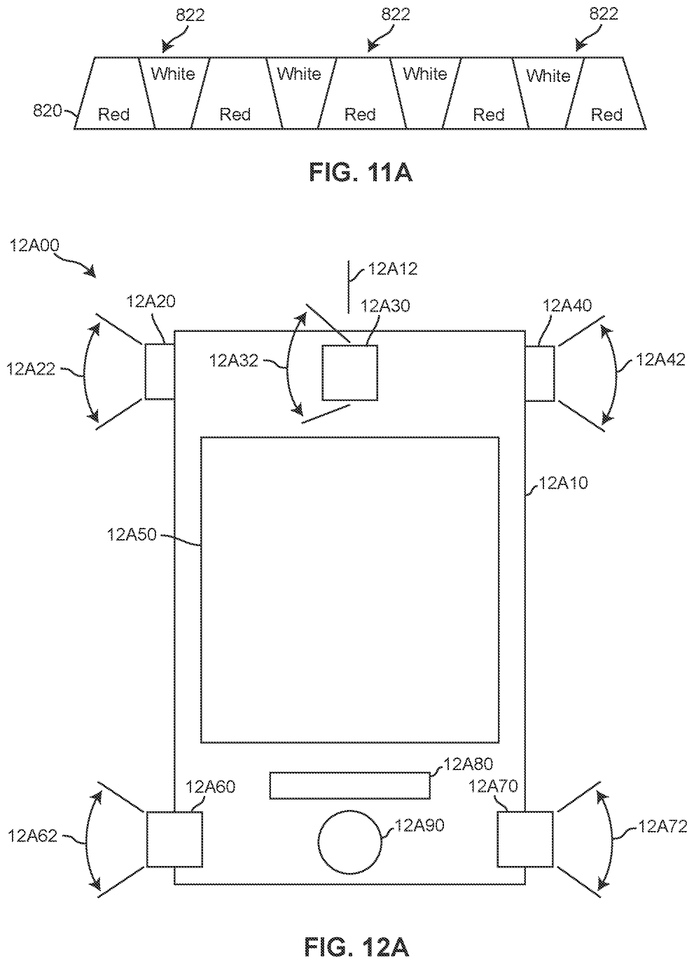

In an example embodiment, as best shown in FIG. 10, the light sources of the light bar the light bar 820 illuminate at the locations 850, 852 and 854 in an orange color to comply with regulations that a vehicle greater than 80 inches in width be so illuminated. In another example embodiment, the light sources of the light bar 820 periodically illuminate then turn off (e.g., flash) at locations 850, 852 and 854 in a yellow color as a cautionary signal. In another example embodiment, the light sources of the light bar 820, 860, 910 or 11B10 illuminate light sources in the shape of an arrow (e.g., pointer) that move (e.g., march, scroll) along the width of the light bar to indicate that traffic move to the side as indicated by the arrow. In another example embodiment, as best seen in FIG. 11, the light sources of the light bar 820, 860, 910 11B10 illuminates in alternating, diagonal stripes of different colors (e.g., red, white, yellow), that may or may not flash on and off, as an emergency signal.

### 3. External Light Fixtures

Manufacturing a light that could be installed (e.g., mounted, affixed) as a headlight or as a taillight at any position on a vehicle (e.g., driver front 12E10, driver rear 12E30, passenger front 12E20, passenger rear 12E40) would simplify inventory and manufacture. A light fixture that includes a programmable light panel may be used emulate headlights, turn lights, taillight and brake lights regardless of where is positioned on the vehicle. However, additional components may be included in the light fixture to enable the vehicle to perform additional functions and to allow the vehicle to interact with an authorized user.

In an example embodiment, light fixture 12A00 includes cameras (e.g., video) 12A20, 12A30 and 12A40, light panel 12A50, microphones 12A60 and 12A70, speaker 12A80 and projector light 12A90. The cameras 12A20, 12A30 and 12A40, light panel 12A50, microphones 12A60 and 12A70, speaker 12A80 and projector light 12A90 are positioned with respect to the housing 12A10 symmetrically about the centerline 12A12 of the light fixture 12A00 thereby enabling the light fixture 12A00 to be positioned at any position on the vehicle (e.g., 12E10, 12E20, 12E30, 12E40) to perform a similar function without structural change (e.g., modification). The 12A20, 12A30 and 12A40 cameras, light panel 12A50, microphones 12A60 and 12A70, speaker 12A80 and projector light 12A90 connect to the housing, so mounting the housing to the vehicle also mounts the 12A20, 12A30 and 12A40 cameras, light panel 12A50, microphones 12A60 and 12A70, speaker 12A80 and projector light 12A90 to the vehicle.

### 3.1 Cameras

The cameras 12A20, 12A30 and 12A40 capture images within their respective fields-of-view. In an example embodiment, as best shown in FIGS. 12A, 12B and 12E, the cameras 12A20, 12A30 and 12A40 each have a vertical field-of-view (“VFOV”) of between 90 and 180° (e.g., 12A22, 12A32, 12A42) and a horizontal field-of-view (“HFOV”) of between 120 and 180° (e.g., 12B22, 12B32, 12B42). While the light fixtures 12A00 are attached to a vehicle (e.g., 12E10, 12E20, 12E30, 12E40), refer to FIG. 12E, the fields-of-view of the cameras overlap. The indicators 12E10, 12E20, 12E30 and 12E40 identify four different instances of the light fixture 12A00 that are positioned at four different locations, front driver-side, front passenger-side, rear driver-side and rear passenger-side respectively on the vehicle.

The HFOV of the cameras of the light fixture 12E10 overlap to capture images in the area on the driver-side and the front of the vehicle, assuming the steering wheel is on the left side of the vehicle. The HFOV of the cameras of the light fixture 12E20 overlap to capture images in the area on the passenger-side and the front of the vehicle. The HFOV of the cameras of the light fixture 12E30 overlap to capture images in the area on the driver-side and the rear of the vehicle. The HFOV of the cameras of the light fixture 12E40 overlap to capture images in the area on the passenger-side and rear of the vehicle. The cameras of each light fixture 12E10, 12E20, 12E30 and 12E40 provide a different viewpoint of the area around the vehicle.

Further, the distance between the cameras on different light fixtures (e.g., 12E10, 12E20, 12E30, 12E40) provide a measure of binoculars vision. For example, the light fixture 12E10 is positioned on the front driver-side corner of the vehicle while the light fixture 12E30 is positioned on the rear driver-side corners vehicle. The cameras of both light fixtures 12E10 and 12E30 capture images on the driver-side of the vehicle; however, the light fixtures 12E10 and 12E30 are positioned far enough apart to provide binoculars vision on the driver-side of the vehicle. The distance between the light fixtures 12E10 and 12E20 provides binoculars vision on the front of the vehicle. The distance between the light fixtures 12E20 and 12E40 provides binoculars vision on the passenger-side of the vehicle. The distance between the light fixtures 12E30 and 12E40 provides binoculars vision on the rear of the vehicle. Images captured using binocular-vision may be used to estimate distances from the cameras to an object.

The cameras 12A20, 12A30 and 12A40 may be capable of capturing images in the infrared light range, not just the visible light range, to be able to detect objects at night. In another embodiment, as best seen in FIGS. 12H and 12I, camera 12A30 is omitted and cameras 12A20 and 12A40 have a HFOV of between 200 and 270°.

Images captured by the cameras 12A20, 12A30 and 12A40 may be analyzed, for example by processing circuit 12J10, to identify objects proximate to the vehicle and/or approaching the vehicle. Images captured by the cameras 12A20, 12A30 and 12A40 may be analyzed to identify the facial features, the physique, and/or the gait of the driver and or other authorized users of the vehicle. Responsive to identifying the driver and/or other authorized users, the processing circuit 12J10 may operate one or more of the vehicle systems 12J20, such as the door locks.

The processing circuit 12J10 may use the images from the cameras 12A20, 12A30 and/or 12A40 to track movement of an object in the vicinity of the vehicle, for example a user as the user travels to or from the vehicle. The processing circuit 12J10 may analyze images from the cameras 12A20, 12A30 and 12A40 to prepare and present, for example on a display of a user interface, a 360° view or nearly 360° view of the area around the vehicle. The processing circuit 12J10 may also analyze the images captured by the cameras 12A20, 12A30 and 12A40 to provide alarms to the user such as to warn of an approaching vehicle, a vehicle in a proximate lane during a lane change or other situations to protect the vehicle and its occupants. The processing circuit 12J10 may store the images captured by some or all of the cameras as a historical record.

The processing circuit 12J10 is part of the light control system 12J00. The light control system 12J00 includes the processing circuit 12J10 and memory 12J12. The memory 12J12 stores information for voice recognition, speech recognition, phrase recognition, and gait recognition for recognizing and authorizing users of the vehicle. Memory 12J12 may also store information for facial recognition of users of the vehicle. The information stored by the memory 12J12 enables the processing circuit 12J10 to identify authorized users and to accept and execute commands from authorized users.

### 3.2 Microphones

The microphones 12A60 and 12A70 capture sounds within their respective fields-of-capture. While the light fixture 12A00 is attached to the exterior of the vehicle (e.g., 12E10, 12E20, 12E30, 12E40), the microphones 12A60 and 12A70 capture sound in an area around the vehicle. In an example embodiment, as best shown in FIGS. 12A and 12C, the microphones 12A60 and 12A70 each have a vertical field-of-capture (“VFOC”) of between 90 and 180° (e.g., 12A62, 12A72) and a horizontal field-of-capture (“HFOC”) of between 200 and 270° (e.g., 12B62, 12B72). While the light fixtures 12A00 are attached to the vehicle, the fields-of-capture of the microphones overlap to provide sound capture around the entire vehicle by two or more microphones. Capture by two or more microphones at any location around the vehicle permits the processing circuit 12J10 to analyze the captured sounds to track movement of an object that makes sounds proximate to the vehicle. The processing circuit 12J10 the analyze both images from the cameras 12A20, 12A30 and 12A40, and sounds from the microphones 12A60 and 12A70 to locate and/or track objects in the vicinity of the vehicle.

The processing circuit 12J10 may perform voice recognition and speech analysis to identify the driver and/or any other authorized user of the vehicle. The processing circuit 12J10 may analyze speech to detect commands from the driver or other authorized user. Commands may include instructions for the processing circuit 12J10 to perform a task or to operate a vehicle system 12J20 in a specified manner. Responsive to identifying the voice of the driver or any other authorized user, the processing circuit 12J10 may operate one or more of the vehicle systems, such as the door locks.

For example, as the user exits the vehicle, the user states the word “lock” or the phrase “lock the doors”. The microphones 12A60 and 12A70 of one or more of the light fixtures 12E10, 12E20, 12E30 and 12E40 is configured to capture the sound and provided it to the processing circuit 12J10 for analysis. The processing circuit 12J10 is configured to analyze the captured sound to detect the word or phrase. The processing circuit 12J10 may further use the captured sound to recognize and authenticate the person who spoke the word or phrase. If the user is an authorized user of the vehicle, the processing circuit 12J10 is configured to control the locking mechanism to lock the doors of the vehicle. The processing circuit 12J10 may also analyze the captured images from the cameras 12A20, 12A30 and 12A40 of the light fixtures 12E10, 12E20, 12E30 and 12E40 to determine that the user is in the vicinity of the vehicle. The processing circuit 12J10 may review the other systems of the vehicle and an announced to the user via the speakers 12A80 of the light fixtures 12E10, 12E20, 12E30 and 12E40 of any situations that the user may want to change prior to leaving the vehicle. For example, if a window are down, the processing circuit 12J10 may inform the user via the speakers 12A80 that the doors are locked, but the windows are still down. At that point the user may inform the processing circuit 12J10 the leaving the windows down is fine for instruct the processing circuit 12J10 to roll up the windows.

### 3.3 Projector Light

Each light fixture 12A00 includes a projector light 12A90. A projector light 12A90 provides a beam of light. While the light fixtures 12A00 are attached to the exterior of the vehicle (e.g., 12E10, 12E20, 12E30, 12E40), the projector light 12A90 projects light in an area around the vehicle. The size (e.g., with, diameter, arc) may be set. In an example embodiment, the beam of light may be moved through an area referred to as a field-of-illumination. The diameter (e.g., size, beam arc) of the beam of light is less than the area of the field-of-illumination. In other words, the area of the field-of-illumination is greater that the area of the beam arc, so the beam of light illuminates only a portion of the area of the field-of-illumination at a time. In an example embodiment, the diameter of the beam is described as a portion of a portion of an arc as opposed to a diameter (e.g., length). In an example embodiment, the beam arc 12D94 is between 10 and 90° as shown in FIG. 12D.

The processing circuit 12J10 is configured to control the projector light 12A90. The processing circuit 12J10 is configured to set the beam are 12D94 of the projector light 12A90. The processing circuit 12J10 is configured to move (e.g., control, direct) the beam of light to illuminate a particular area of the field-of-illumination. In other words, the processing circuit 12J10 is configured to control the direction in which the projector light 12A90 points. The processing circuit 12J10 may analyze the images captured by the cameras 12A20, 12A30 and 12A40 to determine the size of an object proximate to the vehicle and adjust the beam arc 12D94 so that the beam illuminates the object. The processing circuit 12J10 is further configured to set the intensity (e.g., brightness, luminosity) of the light provided by the projector light 12A90.

In an example embodiment, the field-of-illumination includes a vertical field-of-illumination 12A92 (“VFOI”) of between 120 and 180°, see FIG. 12A, and a horizontal field-of-illumination 12D92 (“HFOI”) of between 120 and 180°, see FIG. 12D. The processing circuit 12J10 is configured control the projector light 12A90 so that the beam illuminates a particular area of the field-of-illumination. The processing circuit 12J10 is further configured to control movement of the projector light 12A90 to sweep the beam of light through the field-of-illumination.

In an example embodiment, the processing circuit 12J10 analyzes the images captured by the cameras 12A20, 12A30 and 12A40 and/or the sounds captured by the microphones 12A60 and 12A70 to identify an object positioned or moving proximate to (e.g., in the area around) the vehicle. The processing circuit 12J10 instructs the projector light 12A90 to move its beam to the position of the object to illuminate the object. As the object moves around the vehicle, the processing circuit 12J10 controls the projector light 12A90 to move the beam of light to track the object. Tracking the object means that the processing circuit 12J10 analyzes the images captured by the cameras 12A20, 12A30 and 12A40 and/or the sounds captured by the microphones 12A60 and 12A70 to periodically (e.g., continuously) identify the position of the object in the area around the vehicle and controls the projector light 12A90 to move (e.g., direct) the beam to the new (e.g., updated) position of the object. Tracking the object means that the beam of light follows and illuminates the object as the object moves.

For example, imagine that a user has just exited the vehicle. The cameras 12A20, 12A30 and 12A40 capture images of the user while the microphones 12A60 and 12A70 capture sounds made by the user. In this example, the user audibly states “illuminate my way”. The processing circuit 12J10 analyzes the sound captured by the microphones 12A60 and 12A70 and performs speech recognition to identify the phrase “illuminate my way”. The processing circuit 12J10 controls one or more of the projector lights 12A90 of light fixtures 12E10, 12E20, 12E30 and 12E40 to illuminate the area where the user is positioned. As the user moves around or away from the vehicle, for example toward a house, the processing circuit 12J10 uses the images from the cameras 12A20, 12A30 and 12A40 and/or the sound from the microphones 12A60 and 12A70 to track the movement of the user and to illuminate the area through which the user moves. Once the user is out of range of the cameras 12A20, 12A30 and 12A40, the microphones 12A60 and 12A70 or the beam from the projector light 12A90, the processing circuit 12J10 turns off the projector lights 12A90.

In another example embodiment, the user states “illuminate my way” as the user approaches the vehicle. The processing circuit 12J10 analyzes the captured sound to detect the phrase and controls the projector light 12A90 to illuminate the area of the user and to track movement of the user as the user approaches the vehicle. Once the user enters the vehicle, the processing circuit 12J10 turns the projector light 12A90 off. The processing circuit 12J10 May also turn on the light sources of the light panel 12A50 of one or more of the light fixtures 12E10, 12E20, 12E20 and/or 12E40 to provide additional light.

In another example embodiment, the user verbally issues (e.g., utters, speaks, states) the command “track objects” while in or near the vehicle at night. The processing circuit 12J10 analyzes the images captured by the cameras 12A20, 12A30 and 12A40, including infrared images, and/or the sounds captured by the microphones 12A60 and 12A70 to identify one or more objects in the vicinity of the vehicle. The processing circuit 12J10 instructs each of the projector light 12A90 of the light fixtures 12E10, 12E20, 12E30 and 12E40 to illuminate one or more of the objects. The processing circuit 12J10 may adjust the beam arc 12D94 to fit the size of each object detected or more than one object detected. The beam from one or more projector light 12A90 may illuminate an object depending on the number of objects. The processing circuit 12J10 may adjust the beam arc 12D94 to be sufficiently large to illuminate more than one objects if necessary. As the objects move with respect to the vehicle, the processing circuit 12J10 is configured to track the movements of the objects and to control the projector light 12A90 to track their respective objects. The processing circuit 12J10 may also turn on the light sources of the light panels 12A50 to provide white light at the highest intensity to provide additional light if needed.

In another example, the user states the word “help”. Responsive to this request, the processing circuit 12J10 uses the projector light 12A90 to illuminate objects, in particular people or animals, proximate to the vehicle. The processing circuit 12J10 also illuminates the light sources of the light panels 12A50 of all of the light fixtures 12E10, 12E20, 12E30 and 12E40. The processing circuit 12J10 may further unlock the doors proximate to the user. The processing circuit 12J10 may further activate and alarm and/or call for help using a communication system. The processing circuit 12J10 may further issue a call for help using the speakers 12A80 of the light fixtures 12E10, 12E20, 12E30 and 12E40. Once the processing circuit 12J10 detects that the user has entered the vehicle, it may unlock the doors.

In another example embodiment, the projector light 12A90 of light fixtures 12E30 and 12E40, positioned in the rear of the vehicle, perform the function of a backup light. When the processing circuit 12J10 detects that the user has placed the drivetrain of vehicle systems 12J20 in reverse, the processing circuit 12J10 is configured to instruct the projector light 12A90 to produce light that is directed behind the vehicle to enable the user to view objects behind the vehicle. The processing circuit 12J10 may further monitor the steering system to direct the beams of light from the projector light 12A90 in accordance with the orientation of the front wheels. For example, when the front wheels are directed straight forward, the beams of light from the projector lights 12A90 are pointed directly behind the vehicle. As the steering wheel is turned to direct the front wheels in a rightward direction (assume driver is on the left side of the vehicle when facing forward), the processing circuit 12J10 directs the beams of light from the projector lights 12A90 toward the passenger-side of the vehicle because as the vehicle backs up, it will turn toward the passenger-side. As the steering wheel is turned to direct the front wheels in a leftward direction, the beams of light from the projector lights 12A90 are directed toward the driver-side because as the vehicle backs up it will turn toward the driver-side. In other words, the processing circuit 12J10 monitors the steering system and directs the beams of light from the projector lights 12A90 rearward in the direction where the vehicle be traveling. Further, the processing circuit 12J10 may increase the beam arc 12D94 to its maximum when emulating a backup light to illuminate the widest possible area behind the vehicle.

### 3.4 Speaker

As discussed above, each light fixture 12A00 further includes a speaker 12A80. While the light fixtures 12A00 are attached to the exterior of the vehicle (e.g., 12E10, 12E20, 12E30, 12E40), the speaker 12A80 provides sound in an area around the vehicle. The speakers in the various light fixtures (e.g., 12E10, 12E20, 12E30, 12E40) may be used to provide sound from the infotainment system of the vehicle to the exterior of the vehicle. For example, if the user selects a particular radio channel, the processing circuit 12J10 may direct the signals from the infotainment center to the speakers of the light fixtures 12E10, 12E20, 12E30 and/or 12E40. The user may verbally or via the user interface instruct the processing circuit 12J10 to direct the audio signals from the infotainment center to the speakers of the light fixtures.

The microphones 12A60 and 12A70 and the speaker 12A80 may be used for the user to provide information to and to receive information from the vehicle. For example, the user may audibly ask “what time is it?”. The user's speech is captured by the microphones 12A60 and 12A70. The processing circuit 12J10 analyzes the captured sound and identifies the phrase “what time is it?”. In response to the phrase, the processing circuit 12J10 determines the time of day and provides signals to the speakers 12A80 that causes speakers to audibly state the current time (e.g., it is 11:23 AM”).

In another example embodiment, the user audibly instructs the processing circuit 12J10 to operate the HVAC system to begin cooling the interior of the vehicle at 1:30 pm, which is the time the user anticipate returning to the vehicle after a hike. The processing circuit 12J10 may confirm that it received the instruction by causing the speakers to broadcast the phrase “The HVAC system will begin to cool the vehicle at 1:30 pm”. The processing circuit 12J10 may confirm receipt of any command from an authorized user via the speaker 12A80. For example, the processing circuit may control the speaker 12A80 to playback (e.g., repeat) the command received from the user. In another example, the processing circuit 12J10 causes the speaker to broadcast the word “OK”. The processing circuit 12J10 may also confirm that a command has not been received. If for example, the user spoke indistinctly, the processing circuit 12J10 could control the speakers 12A80 to broadcast the phrase “What did you say?” or “I did not understand” or some other similar phrase. Because the processing circuit 12J10 send phrases to the speaker 12A80 for broadcast and recognizes phrases from the user, the processing circuit 12J10 may conduct a conversation with the user.

### 3.5 Light Panel

The light panel 12A50 connect to the housing. The light panel 12A50 is positioned symmetrically with respect to the centerline 12A12 of the housing 12A10. The light panel 12A50 includes a plurality of light sources. Each light source may produce light a specified color. Each light source may produce light at a specified intensity (e.g., brightness) between a minimum intensity (e.g., off) and a maximum intensity. In an example embodiment, light sources are arranged in rows and columns. A grid of LEDs and control of the LEDs to produce patterns is discussed above with respect to light bars and the emulation of headlights, taillights, brake lights and turn lights. In another example embodiment, the light sources are arranged circularly around a center point in the middle of the light panel 12A50. The light panel 12A50 is programmable in that each light source of the array may be set to provide light of a specific color and at a specific intensity that may be the same or different from the light provided by any other light source. The processing circuit 12J10 is adapted to control each of the light sources of the light panel 12A50.

The light sources of the light panel 12A50 may be of any type (e.g., LED, halogen, solid-state lighting, fluorescent, incandescent, high-intensity discharge). The light sources and the arrangement of the light sources may be similar to the light sources of the light panel 820, the light panel 860, the light panel 910 and/or the light panel 11B10 discussed above. In an example embodiment, the light sources of the light panel 12A50 are LEDs.

The processing circuit 12J10 may control which light sources provide light, the color of the light, and the intensity of the light. The processing circuit 12J10 may control the light sources in accordance with the operation of one or more systems of the vehicle systems 12J20. The processing circuit 12J10 may control the light sources so that the light panel may provide the exterior lights (e.g., headlights, taillights, turn lights) needed for a vehicle. For example, the light fixtures 12E10, 12E20, 12E30, and 12E40, referring to FIGS. 12E and 12G, are positioned on the driver front (e.g., front driver-side), passenger front (e.g., front passenger-side), driver rear (e.g., rear driver-side) and passenger rear (e.g., rear passenger-side) positions of the vehicle. The processing circuit 12J10 programs the light sources of the light panels 12A50 of the light fixtures 12E10 and 12E20 to emulate the headlights 12F12 and 12F22 and the front turn signals 12F14 and 12F24 of the vehicle. The emulation of headlights, taillights, brake lights, turn lights and/or daytime running lights of the vehicle is discussed above with respect to light bars. A light panel is a light bar but is smaller in size than the light bars discussed above. The disclosure regarding light bars above fully applies to the functions, structure and operation of the light panel 12A50.

The processing circuit 12J10 is configured to control the light sources in the areas of the headlights 12F12 and 12F22 to provide a white beam of light forward of the vehicle and directed downward toward the road. Responsive to operation of a high-beam control (e.g., button, switch, mechanism) by the user, the processing circuit 12J10 increases or decreases the intensity other light provided by of the light sources and/or the angle of direction of the beam toward the road to emulate the headlights 12F12 and 12F22. The high-beam control may be positioned on a user interface of the vehicle. The processing circuit 12J10 is configured to control the light sources in the areas of the turn signals 12F14 and 12F24 to provide light of an appropriate color (e.g., orange, red) in accordance with operation of a turn control (e.g., switch, indicator, mechanism) of the vehicle.

The processing circuit 12J10 programs the light sources of the light panels 12A50 of the light fixtures 12E30 and 12E40 to emulate the brake/tail lights 12F32 and 12F42 and the rear turn signals (e.g., lights) 12F34 and 12F44 of the vehicle, as best seen in FIG. 12G. The processing circuit 12J10 is configured to control the light sources in the areas of the turn signals 12F34 and 12F44 to provide light of an appropriate color (e.g., orange, red) in accordance with operation of the turn control of the vehicle. The processing circuit 12J10 is configured to control the light sources in the areas of the brake/tail lights 12F32 and 12F42 to provide light that emulates a taillight when the headlights 12F12 and 12F22 are enabled (e.g., turned on) and a light of greater intensity when the brakes are activated by the user depressing the brake pedal. The processing circuit 12J10 monitors the state of the headlights 12F12 and 12F22, activation/deactivation of the brakes, and the turn mechanism to properly emulate the brake/tail lights 12F32 and 12F42 and the turn signals 12F34 and 12F44.

The LEDs of the light panel 12A50 may provide light in a direction that is suitable for emulating the headlights, taillights, brake lights and turn signals of the vehicle. In an example embodiment, the LEDs provide light (e.g., illuminate) in the direction that is outward from the light panel 12A50 and away from the vehicle. The light from light panel 12A50 illuminate an area in front of the vehicle if the light fixture 12A00 is mounted on a front of the vehicle (e.g., 12E10, 12E20). The light from light panel 12A50 illuminate an area behind the vehicle if the light fixture 12A00 is mounted on a rear of the vehicle (e.g., 12E30, 12E40). The LEDs may be positioned in the light panel 12A50 so that the light from the LEDs travels away from the vehicle in a direction that is downward toward the road so as not to blind the drivers of oncoming vehicles. In another example embodiment, a lens (not shown) is positioned over the entire area of the light panel 12A50. The lens focuses the light from the light sources toward an axis that extends from the center of the light panel 12A50 downward toward the road. The angle of the axis downward toward the road may be slight so that the light shines a distance away from the vehicle before reaching the road.

### 3.6 Alternate Embodiment

The embodiment of the light fixture identified as 12A00 includes three cameras that are positioned symmetrically around the center axis 12A12. The number and arrangement of the cameras enable the light fixture 12A00 to be positioned at any location (e.g., 12E10, 12E20, 12E30, 12E40) on the vehicle. In another example embodiment, as best shown in FIG. 12I, the light fixture 12H00 is the same as the light fixture 12A00 except it omits the camera 12A40. The light fixture 12H02 is the same as the light fixture 12A00 except it omits the camera 12A20. Because the light fixtures 12H00 and 12H02 are not symmetrical around a vertical axis, they cannot be used at any position on the vehicle. Instead, the light fixture 12H00 may be used at the front driver position 12H10 and the rear passenger position 12H40, while the light fixture 12H02 may be used at the front passenger position 12H20 and the rear driver position 12H30 as best seen in FIG. 12H. This example embodiment increases the complexity of maintaining inventory and manufacture; however, the elimination of one camera from the light fixture 12H00 and 12H02 reduces cost.

A front view of the light fixtures 12H00 and 12H02 positioned at 12H10 and 12H20 respectively is shown in FIG. 12I. In all other aspects except for camera field-of-view overlap, the light fixtures 12H00 and 12H02 operate similarly to the light fixture 12A00. Further, the processing circuit 12J10 controls the light fixtures 12H00 and 12H02 similarly to the light fixture of 12A00.

### 4. Collision Detection

### 4.1 Collision Detector

A collision detector 1340 may include any type of device (e.g., detector, sensor: 1310, 1320, 1330) for detecting physical properties. Physical properties may include angular momentum, distance, length, location, size, temperature, velocity, acceleration, wetness, material type, time, volume, square area, height, mass, and slickness. For example, the collision detector may include a radar device for detecting the speed and path (e.g., trajectory) of moving objects relative to the collision detector. The radar may detect the position of stationary objects and a trajectory of the motion detector relative to the stationary objects. The collision detector may include a Lidar detector, a plurality of cameras (e.g., video cameras), a plurality of microphones, an infrared detector, a microwave detector, an ultrasonic detector, a tomographic motion detector, and an RF tomographic motion detector.

In an example embodiment, the sensors of the collision detector 1340 includes, possibly in addition to other sensors, the cameras 12A20, 12A30 and 12A40 and microphones 12A60 and 12A70 of the light fixtures 12E10, 12E20, 12E30 and 12E40 positioned on the vehicle 1300. The sensors 1310-1330 may be positioned at any location on the vehicle 1300. The vehicle 1300 may include a plurality of sensors of different types of which the sensors 1310-1330 are only representative.

The collision detector 1340 includes a processing circuit 2060 and software (e.g., a program for execution) for analyzing the data from the sensors to determine the position of objects relative to the collision detector, the movement of objects relative to the collision detector, the current trajectory of the collision detector relative to objects, the current trajectory of objects relative to the collision detector, a predicted trajectory of the collision detector relative to objects and a predicted trajectory of objects relative to the collision detector. The processing circuit 2060 may, among other things, measure time, predict an amount of time until the occurrence of an event (e.g., collision), control the operation of one or more systems (e.g., steering, breaking, suspension, drivetrain) of the vehicle 1300, predict a geographic location of impact, predict a point of impact on the vehicle 1300, analyze potential alternate routes to avoid or minimize the consequences of an impact, estimate the force of impact, and estimate a coefficient of friction of the surface on which the vehicle 1300 is located. The processing circuit 2060 may further determine how the systems of the vehicle may be operated to alter the movement and/or trajectory of the vehicle 1300 to avoid and/or decrease potential harm to the passengers. The processing circuit 2060 is configured to issue commands to control the systems of the vehicle 1300 in accordance with determining how to avoid collision and/or decrease potential harm to the passengers.

### 4.2 First Example of Operation

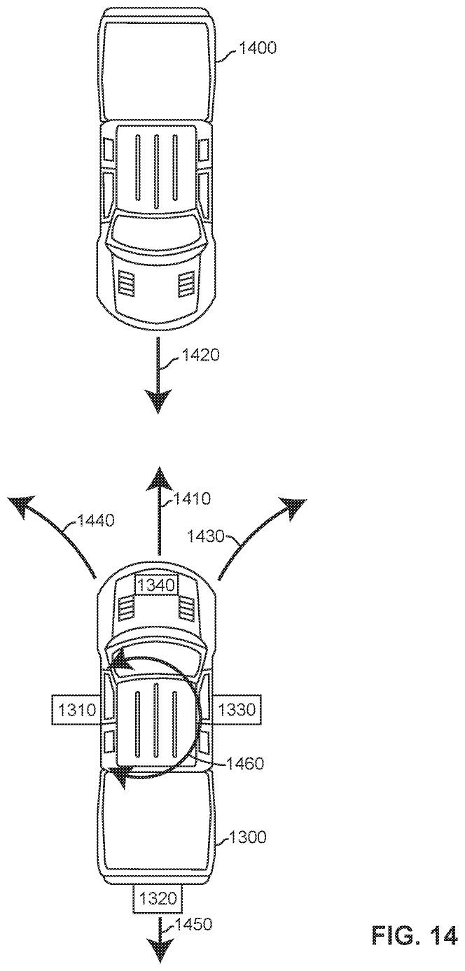

In a first example, as best seen in FIG. 14, of collision detection and avoidance, a first vehicle 1300 travels in a direction of travel 1410 at a first speed. A second vehicle 1400 travels in a direction of travel 1420 at a second speed. The direction of travel 1410 is diametrically opposed to the direction of travel 1420 and is collinear. In other words, vehicle 1300 and vehicle 1400 are headed directly toward each other. Using the sensors 1310-1330, the collision detector 1340 of the first vehicle 1300 detects the speed and the direction of travel 1420 of the second vehicle 1400. The collision detector 1340 determines that based on the direction of travel 1420, the second speed of the second vehicle 1420, the direction of travel 1410, and the first speed of the first vehicle 1300 that a collision is likely and imminent.

The collision detector 1340 uses the information collected by the sensors 1310-1330 to determine possible actions that may be taken to avoid or decrease potential harm to the passengers. Further the collision detector 1340 determines whether or how the systems of the first vehicle 1300 may be used to implement the possible actions. The collision detector 1340 determines that the direction of travel of the second vehicle 1400 is directly toward the first vehicle 1300. Taking the second speed of the second vehicle 1400 into consideration, the collision detector 1340 is configured to determine whether the steering system may be used to direct the first vehicle 1300 to the right along the direction of travel 1430 or to the left along the direction of travel 1440, whether to apply the brakes to decrease the first velocity of the first vehicle 1300, whether the powertrain system may be engaged in reverse to move the first vehicle 1300 along the direction of travel 1450, and/or whether the powertrain system may be engaged to rotate the first vehicle 1300 clockwise or counterclockwise in direction 1460.

In one set of circumstances, the collision detector 1340 determines that there are no objects to the left or to the right of the first vehicle 1300, so veering to the left along the direction of travel 1440 or to the right along the direction of travel 1430 is sufficient to avoid the impact or to reduce the potential harm to the passengers. In such circumstances, the collision detector 1340 configured to control the steering system of the first vehicle 1300 to veer in one direction (e.g., left) or the other (e.g., right).

In another set of circumstances, the collision detector 1340 determines that the brakes should be applied to decrease the first speed of the first vehicle 1300 while veering to the left or to the right along the direction of travel 1440 or the direction of travel 1430, respectively. In another set of circumstances, the collision detector 1340 determines that the drivetrain should be engaged in the reverse direction to provide maximum slowing and possibly some movement along the direction of travel 1450 while also activating the steering system to via veer to the left or to the right out of the direction of travel 1420 of the second vehicle 1400. In another set of circumstances, the collision detector 1340 determines that the first vehicle 1300 should veer to the left or to the right along the direction of travel 1440 or the direction of travel 1430 respectively while engaging the drivetrain so that the wheels on the driver side of the vehicle (e.g., left-hand drive vehicle) slow the speed of their rotation while the wheels on the passenger side increase their speed of the rotation to rotate the vehicle counterclockwise so that the second vehicle 1400 will collide with the rear (e.g., bed, trunk) of the first vehicle 1300 rather than the front or the side of the first vehicle 1300.

The vehicle 1300 need not be fully autonomous for the collision detector 1340 to control the operation of the vehicle 1300 to avoid collision or reduce damage from a collision. The algorithms executed by the processing circuit 2060 may be developed solely for detecting and avoiding collision rather than for the tasks of operating the systems of the vehicle 1300 under normal driving conditions.

### 4.3 Second Example of Operation

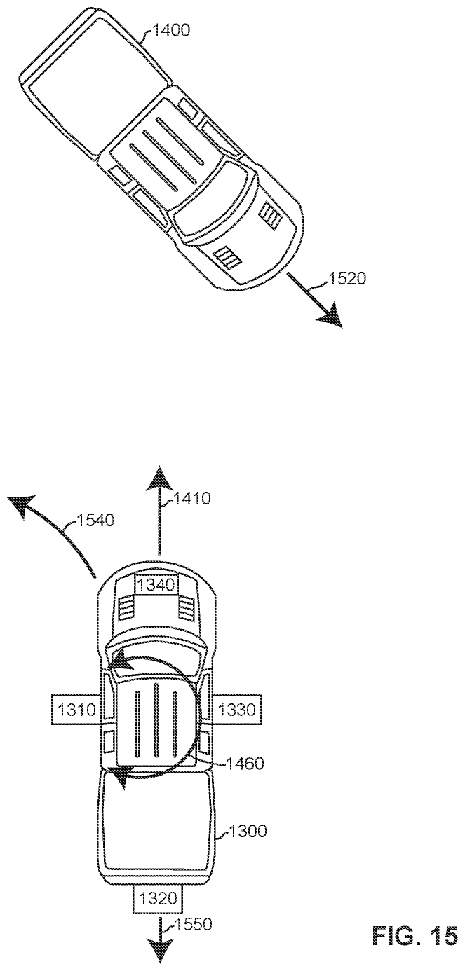

In a second example, best seen in FIG. 15, the first vehicle 1300 is again headed in the direction of travel 1410 while the second vehicle 1400 is headed in the direction 1520 which is at an angle to the direction of travel 1410. In this example, the trajectories of the vehicle 1300 and the vehicle 1400 is not head-on. The collision detector 1340 is configured to detect the speed and the direction of travel of the first vehicle 1300 and the speed and the direction of travel of second vehicle 1400. The collision detector 1340 determines that based on the direction of travel 1520 of the second vehicle 1400, the second speed of the second vehicle 1400, the direction of travel 1410 of the first vehicle 1300, and the first speed of the first vehicle 1300 that a collision under the present conditions, is imminent.

The collision detector 1340 uses the information collected by the sensors 1310-1330 to determine possible actions that may be taken to avoid or decrease potential harm to the passengers. The collision detector 1340 also determines how the systems of the first vehicle 1300 may be operated to implement the actions. The collision detector 1340 determines that the direction of travel 1520 of the second vehicle 1400 is oblique with respect to the direction of travel 1410 of the first vehicle 1300. Taking the second speed of the second vehicle 1400 into consideration, the collision detector 1340 determines that veering to the right would likely increase harm to the passengers of the first vehicle 1300. Due to the first speed of the first vehicle 1300, the collision detector 1340 determines that veering to the left along the direction of travel 1540 would still result in a collision; however, the impact would be along the side or rear of the first vehicle 1300 and not to the front of the vehicle 1300. The collision detector 1340 determines that veering to the left along the direction of travel 1540 in combination with hard braking or reversing the powertrain and the rotation of the tires to, if possible, also move in a rearward direction at least slightly, the collision might be avoided.

In one set of circumstances, the collision detector 1340 instructs the steering system to turn to the left and the braking system to apply the brakes to the rear tires. Under other set of circumstances, the collision detector 1340 instructs the steering system to turn to the left and the power drive to accelerate the rotation of the front tires while increasing the rate of rotation of the rear tire on the passenger side and decreasing the rate of rotation of the rear tire on the driver side to rotate the first vehicle 1300 in the counterclockwise direction.

The sensor 1310, the sensor 1320 and the sensor 1330 may include sensors that detect the characteristics (e.g., slope, width) of the road and/or the condition of the surface of the road. The characteristics and/or condition of the surface of the road (e.g., dry, wet, icy, snow, gravel, asphalt, concrete, flat, rutted, inclined) may be a factor in the action taken by the collision detector 1340. Determining the condition of the surface of the road may include estimating the coefficient of friction of the surface. The collision detector 1340 may use information regarding the condition of the surface of the road to determine how the tires of the first vehicle 1300, and therefore the first vehicle 1300, will respond to forces applied by the powertrain system, the braking system and/or the steering system on the tires.

### 4.4 Third Example of Operation

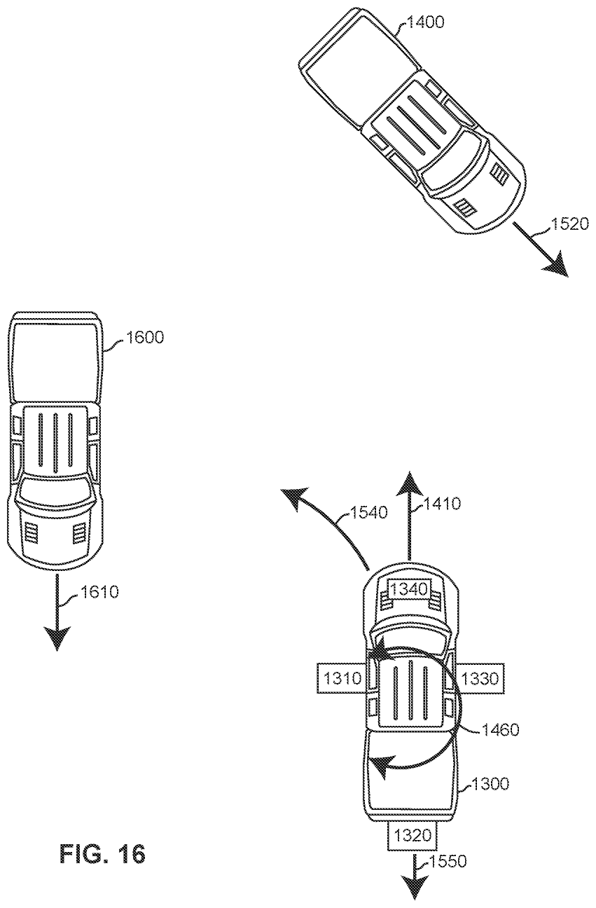

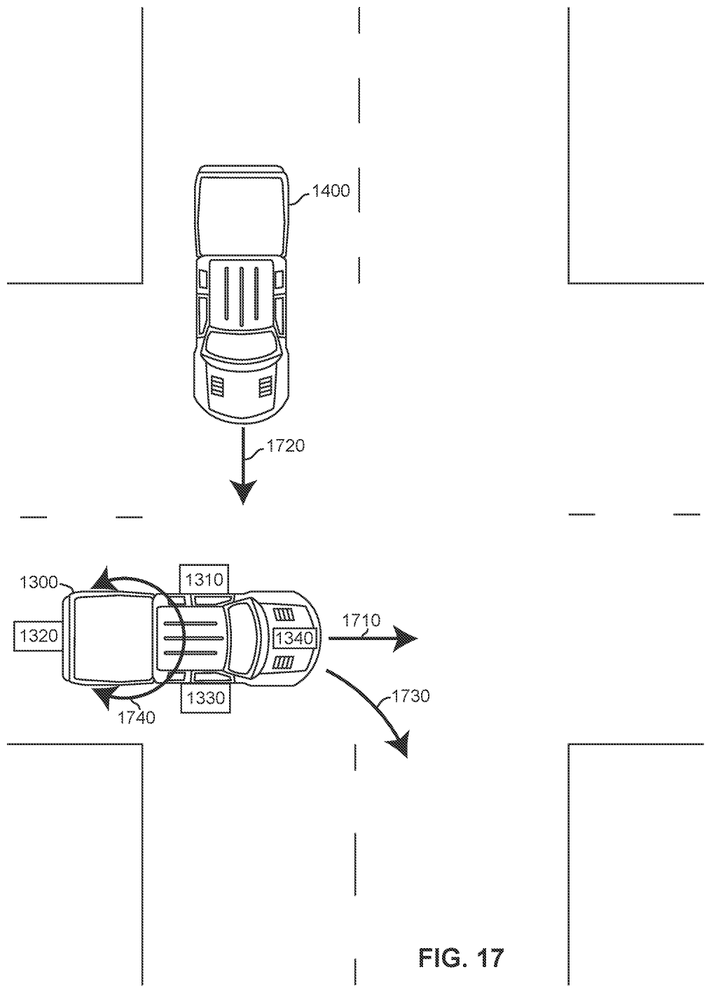

The third example, shown in FIG. 16, is the same as the second example, except a third vehicle 1600, has been added to the scenario. In this example, the speed and directions of travel of the first vehicle 1300 and the second vehicle 1400 are the same as in the second example. The collision detector 1340 detects the same information regarding the first vehicle 1300 and the second vehicle 1400. The collision detector also detects the third speed and direction of travel 1610 of the third vehicle 1600.

The collision detector 1340 is configured to use the data to determine that its options are about the same as in the second example, except that the angle of veering to the left along the direction of travel 1540 needs to be controlled to be able to miss the second vehicle 1400 while not hitting the third vehicle 1600. The collision detector 1340 is adapted to control the steering, the brakes, and/or the powertrain to swerve to the left in between the second vehicle 1400 and the third vehicle 1600.

In one set of circumstances, the third vehicle 1600 may be moving slowly and the second vehicle 1400 may be moving quickly thereby precluding the first vehicle 1300 from swerving to the left along the direction of travel 1540 avoid the second vehicle 1400 without hitting the third vehicle 1600. In such circumstances, the collision detector 1340 may elect to rotate the first vehicle 1300 in a counterclockwise direction so that the orientation of the first vehicle 1300 coincides with the direction of travel of the second vehicle 1400, so when the first vehicle 1300 collides with the second vehicle 1400, the energy of impact is spread along the sides of the first vehicle 1300 and the second vehicle 1400 thereby potentially reducing harm to the occupants.

### 4.5 Fourth Example of Operation

In a fourth example, shown in FIG. 17, the first vehicle 1300 is headed along the direction of travel 1710 at a first speed (e.g., to the right with respect to the page) through an intersection. The second vehicle 1400 is headed along the direction of travel 1720 (e.g., downward with respect to the page) at a second speed into the intersection and toward the first vehicle 1300. The collision detector 1340 of the first vehicle 1300 detects the speed and the direction of travel of travel 1720 of the second vehicle 1400. The collision detector 1340 determines that based on the direction of travel 1720, the second speed of the second vehicle 1420, the direction of travel 1710, and the first speed of the first vehicle 1310 that a collision is imminent.

The collision detector 1340 uses the information collected by the sensors 1310-1330 to determine possible actions that may be taken to avoid collision or decrease potential harm to the passengers. The collision detector 1340 determines that the first vehicle 1300 cannot accelerate sufficiently fast enough to entirely avoid the collision. However, the collision detector 1340 determines that accelerating would move the point of impact from near the driver of the first vehicle 1300 to the rear of the first vehicle 1300. The collision detector 1340 determines that veering to the right along the direction of travel 1730 would further position the rear of the first vehicle 1300 toward the second vehicle 1400. The collision detector 1340 also determines that rotating the first vehicle 1300 clockwise positions the rear of the first vehicle 1300 toward the second vehicle 1400.

In one set of circumstances, the collision detector 1340 is adapted to control the powertrain to accelerate the first vehicle 1300 so the second vehicle 1400 strikes closer to the rear of the first vehicle 1300 as opposed to where the driver is positioned. In another set of circumstances, the collision detector 1340 is adapted to control the powertrain to accelerate the first vehicle 1300 and the steering system to turn the first vehicle 1300 to the right to travel along the direction of travel 1730. In another set of circumstances, the collision detector 1340 controls the powertrain to accelerate the first vehicle 1300 to rotate the first vehicle 1300 clockwise while further controlling the steering system to turn the first vehicle 1300 to the right to travel along the direction of travel 1730. In each case the collision detector 1340 operates to minimize damage and/or injury in a situation where collision cannot be averted.

### 4.6 Fifth the Example of Operation

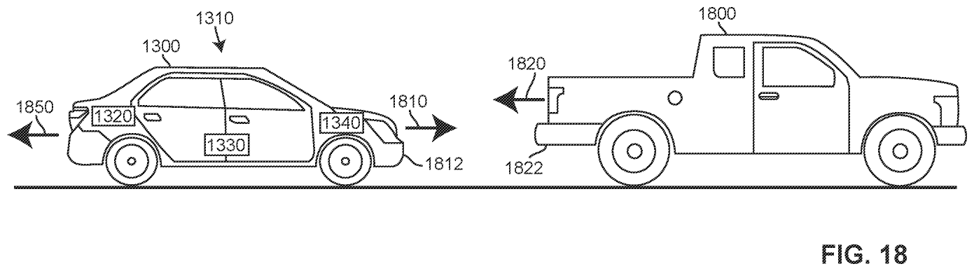

In a fifth example, shown in FIG. 18, the first vehicle 1300 and the second vehicle 1800 are headed directly toward each other along the direction of travel 1810 and the direction of travel 1820 respectively. In this example, the speed of the first vehicle 1300 and the second vehicle 1800 is relatively low; however, collision is likely. In the situation, the collision detector 1340 detects that the bumper 1822 of the second vehicle 1800 is significantly higher than the bumper 1812 on the first vehicle 1300. So, even though the speed of the first vehicle 1300 and the second vehicle 1800 toward each other is low, the bumper 1822 of the second vehicle 1800 will bypass the bumper 1812 of the first vehicle 1300 to possibly cause significant damage to the first vehicle 1300.

Under the circumstances, the collision detector 1340 is configured to control the suspension system of the first vehicle 1300 to raise the height of the first vehicle 1300 so the bumper 1812 is at or near the height of the bumper 1822 of the second vehicle 1800. Raising the bumper 1812 to be about the same height as the bumper 1822 allows the bumper 1812 to perform its function of protecting the first vehicle 1300 during a low-speed collision.

### 4.7 Sixth the Example of Operation

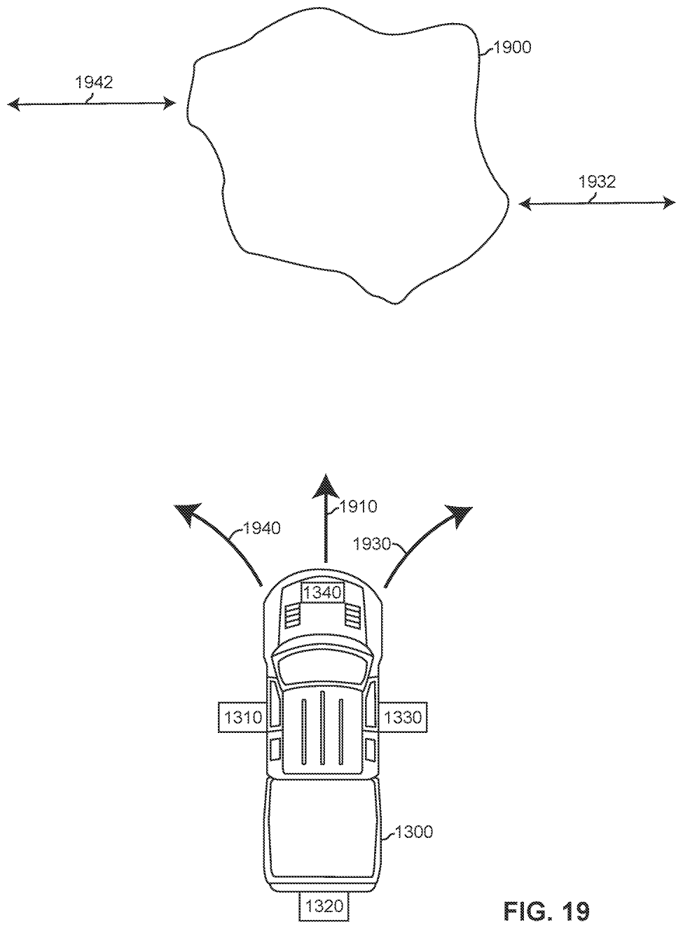

In a sixth example, shown in FIG. 19, a boulder 1900 has just broken off a cliff and fallen onto the road ahead of the first vehicle 1300. The collision detector 1340 detects boulder 1900. The collision detector 1340 is configured to determine that the direction of travel 1910 of the first vehicle 1300 is directly toward the boulder 1900. The collision detector 1340 detects that the boulder 1900 is not moving. The collision detector 1340 determines the distance between the first vehicle 1300 and the boulder 1900. The collision detector detects the speed of the first vehicle 1300 and determines an amount of time under the current conditions before impact of the first vehicle 1300 with the boulder 1900. The collision detector detects the distance 1942 between the edge of the boulder and the side of the road to the left and the distance 1932 between the edge of the boulder and the side of the road to the right. The collision detector 1340 further determines the condition of the road on which the first vehicle 1300 is traveling.

The collision detector 1340 is configured to use the information collected by the sensors 1310-1330 to determine possible actions that may be taken to avoid collision or decrease potential harm to the passengers. The collision detector 1340 determines that the first vehicle 1300 can fit between the edge of the boulder on either the left or the right side of the road, so swerving to the left along the direction of travel 1940 or swerving to the right along the direction of travel 1930 will avert collision. The collision detector 1340 determines that due to the road conditions (e.g., gravel road) that the first vehicle 1300 cannot stay on the present course 1910 (e.g., direction of travel 1910) and apply the brakes or use the powertrain to stop the first vehicle 1300 before colliding with the boulder 1900. Accordingly, the collision detector 1340 applies the brakes to slow as much as possible without skidding or sliding and controls the steering system to steer either to the right along direction of travel 1930 or to the left along direction of travel 1940 to drive past the boulder.

### 4.8 Collision Detector Embodiment

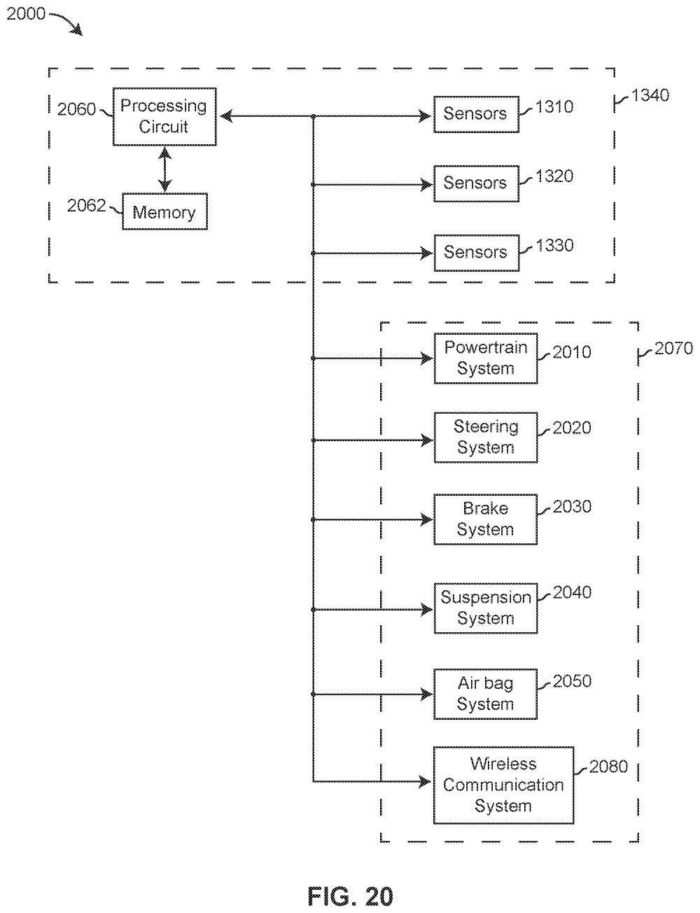

An embodiment of a collision system 2000, as best seen in FIG. 20, includes the collision detector 1340 and the vehicle systems 2070. In an example embodiment, the vehicle systems 2070 include the powertrain system 2010, the steering system 2020, the brake system 2030, the suspension system 2040 and the airbag system 2050. The collision detector 1340 includes the processing circuit 2060, the memory 2062 and the sensors 1310-1330. The processing circuit 2060 is configured to communicate with the sensors 1310-1330 and the vehicle systems 2070 via a bus and/or a wireless connection (e.g., communication link). The processing circuit 2060 is configured to receive detected information from the sensors 1310-1330. The processing circuit 2060 is configured to use the information from the sensors 1310-1330 to make decisions regarding protecting the passengers of the vehicle. The processing circuit 2060 provides instructions to the vehicle systems 2070 to operate one or more of the systems of the vehicle system 2070 to avoid collision if possible and/or two reduce potential injury to the occupants of the vehicle 1300.

In an example embodiment, the collision detector 1340 completely controls the vehicle systems 2070 to the exclusion of the driver in response to detecting a likely collision. For example, in the situation shown in FIG. 17, the driver of the first vehicle 1300 may respond to oncoming second vehicle 1400 by accelerating in the hope of avoiding a collision. However, in this embodiment, the collision detector 1340 has determined that acceleration alone cannot avoid collision, so regardless of any action taken by the driver, the processing circuit 2060 operate the steering system 2020 to change the direction of travel to the direction 1730 and to rotate the first vehicle 1300 in a clockwise direction so the second vehicle 1400 collides with the back of the first vehicle 1300 instead of with the side of the first vehicle 1300 near the driver. In this example embodiment, the reaction of the driver with respect to the accelerator, the brake pedal and/or the steering wheel is ignored by the collision detector 1340. The collision detector 1340 completely controls the response of the first vehicle 1300 to the approaching second vehicle 1400.

In another example embodiment, the collision detector 1340 controls the vehicle systems 2070 to augment or improve actions taken by the driver. In this example embodiment, the collision detector 1340 does not overrule the actions taken by the driver. For example, referring again to FIG. 17, responsive to seeing the oncoming second vehicle 1400, the driver of the first vehicle 1300 depresses the accelerator in the hope of escaping a collision. The collision detector 1340 assists the driver by monitoring the drivetrain and the wheels of the first vehicle 1300 to reduce slip of the wheels against the road service thereby improving the acceleration of the first vehicle 1300. Slip of the wheels against the surface of the road decreases the acceleration of a vehicle. So, the collision detector 1340 operates to reduce wheel slip to augment the drivers decision to accelerate to avoid the collision. Each time a wheel slips, the collision detector 1340 reduces the power (e.g., torque) to the wheel to reduce slip and thereby to maximize acceleration. In another example, in addition to reducing wheel slip, the collision detector 1340 causes the first vehicle 1300 to rotate slightly clockwise to direct the area of impact toward the rear of the first vehicle 1300.

In another example embodiment, the collision detector 1340 completely controls the vehicle systems 2070 to avoid collision if possible, until the driver acts to override any action taken by the collision detector 1340. Upon being overridden by the driver, the collision detector 1340 permits the driver to fully control the vehicle systems 2070 and to respond to the situation. For example, referring to FIG. 17, responsive to detecting the oncoming second vehicle 1400, the collision detector 1340 controls the steering system 2020 to steer the vehicle in the direction 1730; however, the moment the driver turns the steering wheel to stop the first vehicle 1300 from veering to the right in direction 1730, the collision detector 1340 permits the driver to have full control of the vehicle systems 2070.

The vehicle systems 2070 may further include the light bars and/or the taillights discussed herein. In response detecting a possible collision, the collision detector 1340 may further operate the light bars and/or the taillights of the first vehicle 1300 to increase the visibility of the first vehicle 1300 to possibly attract the attention of the driver of the second vehicle 1400 to possibly avoid collision. The vehicle systems may further include the light fixtures 12A00, 12H00 and/or 20H02 discussed herein. In response to detecting a possible collision, the collision detector 1340 may further operate the light panels 12A50, the projector light 12A90 and/or the speakers 12A80 to flash and make noise to possibly attract the attention of the driver in the second vehicle 1400 to possibly avoid collision. The vehicle systems 2070 may further include the sound system described herein. In response to detecting a possible collision, the collision detector may communicate with the driver via the sound system. Communications with the driver may include making a noise to draw the attention of the driver to the potential collision. Communications may further include instructions to the driver. Directions as to actions to take or to advise the driver to permit the collision detector to respond to the situation.

In another example embodiment, both the first vehicle 1300 and the second vehicle 1400 include collision detector 1340. Further, the vehicle systems 2070 includes a wireless communication system 2080. The wireless communication system 2080 of the first vehicle 1300 is configured to establish wireless communication with the wireless communication system 2080 of the second vehicle 1400. The first collision detector 1340 of the first vehicle 1300 is configured to communicate with the second collision detector 1340 of the second vehicle 1400 via their respective wireless communication systems 2080. Upon either or both the first vehicle 1300 and the second vehicle 1400 detecting a potential collision, the first collision detector 1340 and the second collision detector 1340 determines ways to avoid collision or decrease damage; however, the first collision detector 1340 may coordinate the actions that it considers with actions that may be taken by the second collision detector 1340. The first collision detector 1340 and the second collision detector 1340 may agree upon actions to be taken by each to attempt to avoid collision or to reduce damage. Cooperative action taken by two or more collision detectors 1340 increases the likelihood of avoiding collision or reducing damage.

For example, referring to FIG. 14, the first collision detector 1340 of the first vehicle 1300 and the second collision detector 1340 of the second vehicle 1400 may agree that the first vehicle 1300 will swerve to the right along the direction of travel 1430 while the second vehicle 1400 will swerve to the right, from the perspective of the driver of the vehicle 1400, to potentially avoid collision. The collision detector 1340 of the first vehicle 1300 and the collision detector 1340 of the second vehicle 1400 may also agree to apply their respective breaks to reduce their velocity as they each turn to their respective rights.

In another example, referring to FIG. 15, the first collision detector 1340 of the first vehicle 1300 and the second collision detector 1340 of the second vehicle 1400 may agree that both the first vehicle 1300 will veer to the left from the perspective of the respective drivers while the first vehicle 1300 breaks to decrease velocity and the second vehicle 1400 accelerates to increase velocity.

In another example, referring to FIG. 16, the first collision detector 1340, second collision detector 1340 and third collision detector 1340 of the first vehicle 1300, the second vehicle 1400 and the third vehicle 1600 agree that the vehicle 1300 will turn to the left along the direction of travel 1540, the vehicle 1400 will accelerate and veer to the left from the perspective of the driver of the vehicle 1400 and the vehicle 1600 will accelerate and veer to the right from the perspective of the driver of the vehicle 1600.

In another example, referring to FIG. 17, the collision detector 1340 of the vehicle 1300 and the collision detector 1340 of the vehicle 1400 agree that the vehicle 1400 will apply maximum braking without skidding and turned hard to the right, from the perspective the driver of the vehicle 1400, and the vehicle 1300 will turn to the right along the direction of travel 1730 and break if necessary to avoid hitting the curb.

In another example, referring to FIG. 18, the collision detector 1340 of the vehicle 1300 and the collision detector 1340 of the vehicle 1800 agree that both the vehicle 1300 and the vehicle 1800 will immediately stop to completely avoid collision. The scenario raises the possibility that the collision detector 1340 may be active to avoid collision even while the users are not in the vehicle. In the situation of FIG. 18, assume that vehicle 1300 is an occupied and the driver of the vehicle 1800 is backing up to exit a parallel parking place. In the event that the driver of the vehicle 1800 is not painful attention to exiting the parking place, the collision detector 1340 of vehicle 1300 may be active and inform the collision detector 1340 of the vehicle 1800 that a collision is imminent. The collision detector 1340 of the vehicle 1800 by itself likely would have detected the collision and braked to avoid it. However, assume that the vehicle 1800 is also unoccupied. In a situation in which placing the vehicle 1800 in “park” does not fully immobilize the vehicle 1800 so that he can roll backwards into vehicle 1300. In this situation either or both collision detectors may detect the imminent collision, but in this case, the collision detector 1340 in vehicle 1800 may act to stop the collision by applying the brakes. Further, the collision detector 1340 in vehicle 1300 may further reduce the chance of damage by operating suspension to raise the level of the bumper 1812 of the vehicle 1300.

When two collision detectors 1340 of two different vehicles communicate with each other regarding a potential collision, the collision detectors 1340 identify the geographic location, their direction of travel, their speed, and the likely geographic location of the collision. The information communicated between the collision detector 1340 of the two different vehicles is sufficient for each vehicle to identify the location of the other vehicle and for collision detector 1342 identify the current situations that will lead to a possible collision.

The collision detectors 1340 of the different vehicles may scan for surrounding objects, if not continuously aware of surrounding objects, determine a potential plan for avoiding collision or reducing damage. The possible plans may be ranked by likelihood of success to avoid collision and/or reduce damage. The potential actions that may be taken are described with respect to the proposed geographic route of travel, proposed speed, proposed change in speed and any other factor involved in collision avoidance. The collision detectors 1340 applied the same rules in assessing the likelihood of success of each proposed action. The collision detectors then agree as to the actions that will be taken by each vehicle. The proposed actions are measured from the viewpoint of each vehicle individual. In a complex situation, if the actions proposed by the first vehicle will reduce the damage to the first vehicle yet because greater damage to the second vehicle, the second vehicle is not obligated to accept the proposed plan of the first vehicle, but each collision detector 1340 agree to disagree and each vehicle will take actions that are in its best interest.

### Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A light fixture for mounting to a vehicle to provide lighting outside of the vehicle, the light fixture comprising:
a housing configured to mount to the vehicle on a front and a rear of the vehicle without structural modification;
a light panel mounted to the housing, the light panel positioned symmetrically with respect to a centerline of the housing, the light panel includes a plurality of light sources; a light from the plurality of light sources configured to illuminate an area around the vehicle, the light panel further configured to emulate one or more of a headlight, a taillight, a brake light, a turn light and a daytime running light;
three cameras mounted to the housing, the three cameras positioned symmetrically with respect to the centerline of the housing, each camera configured to capture one or more images within its respective field-of-view in the area around the vehicle;
two microphones mounted to the housing, the two microphones positioned symmetrically with respect to the centerline of the housing, each camera configured to capture a sound within its respective field-of-capture in the area around the vehicle;
a speaker positioned on the housing, the speaker configured to provide sound to the area around the vehicle;
a projector light positioned on the housing, the projector light configured to provide a beam of light within a field-of-illumination in the area around the vehicle, the field-of-illumination is greater than a beam arc of the projector light; and
a processing circuit, the processing circuit configured to: receive the one or more images from the three cameras, receive the sound from the two microphones, set the beam arc of the projector light and direct the beam of light to illuminate a particular area of the field-of-illumination; wherein:
the processing circuit analyzes the one or more images and the sound to identify an object positioned in the area around the vehicle; and
the processing circuit directs the beam of light to point toward the object to illuminate the object.

2. The light fixture of claim 1 wherein the processing circuit directs the beam of light to track the object as the object moves in the area around the vehicle.

3. The light fixture of claim 1 wherein the processing circuit turns on the plurality of light sources of the light panel to provide light to further illuminate the area around the object.

4. The light fixture of claim 1 wherein the processing circuit analyzes the sound to identify a voice of an authorized user of the vehicle.

5. The light fixture of claim 4 wherein:
the processing circuit analyzes the sound to identify a command uttered by the authorized user of the vehicle; and
response to the command, the processing circuit is configured to operate one or more vehicles systems.

6. The light fixture of claim 5 wherein the processing circuit is configured to operate the speaker to confirm receipt of the command.

7. A vehicle comprising:
a first light fixture, a second light fixture, a third light fixture and a fourth light fixture, each light fixture includes:
(a) a housing configured to mount to the vehicle,
(b) a light panel mounted to the housing, the light panel positioned symmetrically with respect to a centerline of the housing, the light panel includes a plurality of light sources; a light from the plurality of light sources configured to illuminate an area around the vehicle, the light panel further configured to emulate one or more of a headlight, a taillight, a brake light, a turn light and a daytime running light,
(c) three cameras mounted to the housing, the three cameras positioned symmetrically with respect to the centerline of the housing, each camera configured to capture one or more images within its respective field-of-view in the area around the vehicle,
(d) two microphones mounted to the housing, the two microphones positioned symmetrically with respect to the centerline of the housing, each camera configured to capture a sound within its respective field-of-capture in the area around the vehicle,
(e) a speaker positioned on the housing, the speaker configured to provide sound to the area around the vehicle, and
(f) a projector light positioned on the housing, the projector light configured to provide a beam of light within a field-of-illumination in the area around the vehicle, the field-of-illumination is greater than a beam arc of the projector light; and
a processing circuit, the processing circuit configured to: receive the one or more images from the three cameras of each light fixture, receive the sound from the two microphones of each light fixture, set the beam arc of the projector light of each light fixture and direct the beam of light of each projector light of each light fixture to illuminate a particular area of the field-of-illumination of each projector light; wherein:
each light fixture is mounted to an exterior of the vehicle;
the first light fixture, the second light fixture, the third light fixture and the fourth light fixture are mounted on a front driver-side, a front passenger-side, a rear driver-side, and a rear passenger-side of the vehicle respectively;
the three cameras of the first light fixture are configured to capture images of the area on a driver-side and a front of the vehicle, the three cameras of the second light fixture are configured to capture images of the area on a passenger-side and a front of the vehicle, the three cameras of the third light fixture are configured to capture images of the area on the driver-side and a rear of the vehicle, the three cameras of the fourth light fixture are configured to capture images of the area on the passenger-side and the rear of the vehicle, whereby the three cameras of each light fixture provides a different viewpoint of the area around of the vehicle;
the processing circuit analyzes the one or more images from the three cameras of at least one of the first light fixture, the second light fixture, the third light fixture and the fourth light fixture, and the sound from the two microphones of at least one of the first light fixture, the second light fixture, the third light fixture and the fourth light fixture to identify an object in the area around the vehicle; and
the processing circuit directs the beam of light from the projector light of at least one of the first light fixture, the second light fixture, the third light fixture and the fourth light fixture to point toward the object to illuminate the object.

8. The vehicle of claim 7 wherein the processing circuit directs the beam of light from the projector light of at least one of the first light fixture, the second light fixture, the third light fixture and the fourth light fixture to track the object as the object moves in the area around the vehicle.

9. The vehicle of claim 7 wherein the processing circuit turns on the plurality of light sources of the light panel of at least one of the first light fixture, the second light fixture, the third light fixture and the fourth light fixture to provide light to further illuminate the area around the object.

10. The vehicle of claim 7 wherein the processing circuit analyzes the sound from the two microphones of at least one of the first light fixture, the second light fixture, the third light fixture and the fourth light fixture to identify a voice of an authorized user of the vehicle.

11. The vehicle of claim 10 wherein:
the processing circuit analyzes the sound from the two microphones of at least one of the first light fixture, the second light fixture, the third light fixture and the fourth light fixture to identify a command uttered by the authorized user of the vehicle; and
response to the command, the processing circuit is configured to operate one or more vehicles systems.

12. The vehicle of claim 11 wherein the processing circuit is configured to operate the speaker of at least one of the first light fixture, the second light fixture, the third light fixture and the fourth light fixture to confirm receipt of the command.

13. The vehicle of claim 7 wherein the processing circuit is further configured to control the plurality of light sources of the light panel of the first light fixture and the second light fixture to respectively emulate a headlight and a turn signal on each light panel.

14. The vehicle of claim 13 wherein the processing circuit controls a portion of the plurality of light sources to increase or decrease an intensity of the light provided by the portion of the plurality of light sources to emulate the headlight in accordance with an operation of a high-beam control.

15. The vehicle of claim 13 wherein the processing circuit controls a portion of the plurality of light sources to turn on or off the light provided by the portion of the plurality of light sources to emulate the turn light in accordance with an operation of a turn control.

16. The vehicle of claim 7 wherein the processing circuit is further configured to control the plurality of light sources of the light panel of the third light fixture and the fourth light fixture to respectively emulate a taillight, a brake light and a turn signal on each light panel.

17. The vehicle of claim 16 wherein the processing circuit controls a portion of the plurality of light sources to increase or decrease an intensity of the light provided by the portion of the plurality of light sources to emulate the brake light in accordance with an operation of a brake pedal.

18. The vehicle of claim 16 wherein the processing circuit controls a portion of the plurality of light sources to turn on or off the light provided by the portion of the plurality of light sources to emulate the turn light in accordance with an operation of a turn control.
